(19) United States
(12) Patent Application Publication
(10) Pub. No.: US 2026/0361927 A1
(43) Pub. Date: Nov. 12, 2026

(54) CODING METHOD AND APPARATUS, DECODING METHOD AND APPARATUS, AND DEVICE AND STORAGE MEDIUM

(71) Applicant: HANGZHOU HIKVISION DIGITAL TECHNOLOGY CO., LTD., Hangzhou (CN)

(72) Inventors: Dongping PAN, Hangzhou (CN); Fangdong CHEN, Hangzhou (CN); Yucheng SUN, Hangzhou (CN); Xiaoyang WU, Hangzhou (CN); Shiyi GAO, Hangzhou (CN)

(21) Appl. No.: 19/129,157

(22) PCT Filed: Jan. 12, 2024
(86) PCT No.: PCT/CN2024/072139

§ 371 Date: May 12, 2025

(30) Foreign Application Priority Data
Nov. 14, 2022 (CN) 202211421087.0

(51) Int. Cl. H04N 19/91; H04N 19/124; H04N 19/176; H04N 19/70

(52) U.S. Cl. CPC H04N 19/91; H04N 19/124; H04N 19/176; H04N 19/70

(57) ABSTRACT

A decoding method includes: acquiring a permission level of a user and a permission level of a current coding unit; acquiring a to-be-parsed code stream of the current coding unit according to the permission level of the user and the permission level of the current coding unit, wherein the code stream is acquired from internal code stream information of a current frame, and the code stream information of the current frame comprises a code stream with a lowest permission level and at least one code stream with a permission level greater than the lowest permission level; and acquiring an entropy decoder corresponding to permission levels according to the permission level of the user, the permission level of the current coding unit, and a corresponding code stream, and parsing the to-be-parsed code stream to obtain a reconstructed image block of the current coding unit.

### CROSS-REFERENCE TO RELATED APPLICATIONS

This application claims priority to Chinese Patent Application No. 202211421087.0, filed on Nov. 14, 2022, which is incorporated herein by reference.

### TECHNICAL FIELD

The present disclosure relates to the field of image processing technology, and in particular, to encoding and decoding methods, apparatuses and devices and storage media.

### BACKGROUND

As people pay more and more attention to personal sensitive information protection under monitoring devices, demands for video sensitive information protection technology are increasingly higher. Video sensitive information protection is that, by performing processing such as pixelation, blurring or scrambling on a local sensitive information region in a video image, an image in the sensitive information region is unrecognizable, while original contents in other regions are retained and are normally visible. When an event of endangering public security occurs, in order to restore original contents from a monitoring video, a collected video stream is currently processed into two-path video streams. One-path video stream is not subjected to sensitive information protection processing, and original video frames are retained for being encoded (visible to users with a non-lowest permission level); the other path video stream is subjected to the sensitive information protection processing (such as scrambling, pixelation or blurring), and video frames after the sensitive information protection processing are encoded (visible to both the users with the non-lowest permission level and users with a lowest permission level). However, encoding and decoding at least two-path videos for users with different permission levels result in low efficiency and large resource consumption. At present, users are divided with only two permission levels. If there are more permission levels for users, it will be even more difficult to meet requirements.

### SUMMARY

In view of this, embodiments of the present disclosure provide encoding and decoding methods, apparatuses and devices and storage media, which is intended to solve the technical problem in related art that encoding and decoding at least two-path videos for users with different permission levels result in low efficiency and large resource consumption.

An embodiment of the present disclosure provides a decoding method, including: acquiring a permission level of a user and a permission level of a current coding unit; acquiring a to-be-parsed code stream of the current coding unit according to the permission level of the user and the permission level of the current coding unit, where the code stream is acquired from internal code stream information of a current frame, and the code stream information of the current frame includes a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level includes a code stream with a lowest permission level and at least one code stream with a permission level greater than the lowest permission level; and acquiring an entropy decoder corresponding to permission levels according to the permission level of the user, the permission level of the current coding unit, and a corresponding code stream, and parsing the to-be-parsed code stream to obtain a reconstructed image block of the current coding unit.

In an embodiment of the present disclosure, acquiring the permission level of the current coding unit includes: acquiring the permission level of the current coding unit from an image header of the current frame or internal code stream information with a non-permission level of the current frame.

In an embodiment of the present disclosure, the current coding unit has only one permission level.

In an embodiment of the present disclosure, when the permission level of the current coding unit is acquired from the image header of the current frame, in response to determining that the current coding unit corresponds to a plurality of permission levels, a highest permission level in the plurality of permission levels is used as the permission level of the current coding unit.

In an embodiment of the present disclosure, acquiring the to-be-parsed code stream of the current coding unit according to the permission level of the user and the permission level of the current coding unit includes: acquiring the to-be-parsed code stream of the current coding unit according to the permission level of the user and the permission level of the current coding unit, where the to-be-parsed code stream includes an adjustment parameter code stream and a related encoding coefficient code stream of the current coding unit.

In an embodiment of the present disclosure, the adjustment parameter code stream includes a quantization step adjustment parameter code stream, and acquiring the to-be-parsed code stream of the current coding unit according to the permission level of the user and the permission level of the current coding unit includes: acquiring a to-be-parsed related encoding coefficient code stream of the current coding unit according to the permission level of the user and the permission level of the current coding unit; and acquiring the quantization step adjustment parameter code stream from code streams with a lowest permission level.

In an embodiment of the present disclosure, acquiring the entropy decoder corresponding to the permission levels according to the permission level of the user, the permission level of the current coding unit, and the corresponding code stream, and parsing the to-be-parsed code stream include: acquiring the entropy decoder corresponding to the permission levels according to the permission level of the user, the permission level of the current coding unit, and the corresponding code stream, acquiring a set of contexts, and parsing the to-be-parsed code stream.

In an embodiment of the present disclosure, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

In an embodiment of the present disclosure, when contexts are updated, only contexts of some syntax elements corresponding to the current coding unit or contexts of all syntax elements corresponding to the current coding unit are updated.

In an embodiment of the present disclosure, a coding unit with a non-lowest permission level uses a first set of contexts of a coding unit with a lowest permission level as second set of contexts thereof, only the coding unit with the lowest permission level is able to update its first set of contexts, and the coding unit with the non-lowest permission level is not able to update any context.

In an embodiment of the present disclosure, in response to the permission level of the current coding unit being the same as or higher than a permission level of a previous coding unit, contexts of the previous coding unit are updated, and in response to the permission level of the current coding unit being lower than the permission level of the previous coding unit, the contexts of the previous coding unit are initialized.

In an embodiment of the present disclosure, current coding units with different permission levels each use a set of contexts, and current coding units with a same permission level share a set of contexts.

In an embodiment of the present disclosure, acquiring the to-be-parsed code stream of the current coding unit according to the permission level of the user and the permission level of the current coding unit includes: acquiring the to-be-parsed code stream of the current coding unit according to the permission level of the user, the permission level of the current coding unit, and at least one of a start code or an end code of a code stream with the permission level of the current coding unit.

In an embodiment of the present disclosure, splicing manners of code streams of different coding units are frame-level splicing manners, and where acquiring the to-be-parsed code stream of the current coding unit according to the permission level of the user, the permission level of the current coding unit, and at least one of the start code or the end code of the code stream with the permission level of the current coding unit includes: reading at least one of: a position of an end code of the current frame, or a position of a start code of a next frame; and according to the permission level of the user and the permission level of the current coding unit, in response to the current coding unit being a first coding unit under a current permission level of the current frame, deriving a start position of a code stream of the current coding unit based on at least one of the position of the end code of the current frame or the position of the start code of the next frame, and a start code of a code stream under a current permission level or length information of a code stream under a previous permission level of the current permission level; otherwise, directly acquiring the start position of the code stream of the current coding unit, where the current permission level refers to the permission level corresponding to the current coding unit, so that the to-be-parsed code stream is parsed, and after completion of parsing, a start position of the code stream with the permission level corresponding to the current coding unit is updated.

In an embodiment of the present disclosure, splicing manners of code streams of different coding units are slice-level splicing manners, and where acquiring the to-be-parsed code stream of the current coding unit according to the permission level of the user, the permission level of the current coding unit, and at least one of the start code or the end code of the code stream with the permission level of the current coding unit includes: reading a start position of a code stream with a non-lowest permission level, and at least one of a position of a start code of a next slice or a position of an end code of a current slice; and according to the permission level of the user and the permission level of the current coding unit, in response to the current coding unit being a first coding unit under a current permission level of the current slice, deriving a start position of a code stream of the current coding unit based on at least one of the position of the end code of the current slice or the position of the start code of the next slice, and a start code of a code stream under a current permission level or length information of a code stream under a previous permission level of the current permission level; otherwise, directly acquiring the start position of the code stream of the current coding unit, so that the to-be-parsed code stream is parsed, and after completion of parsing, a start position of the code stream with the permission level corresponding to the current coding unit is updated.

In an embodiment of the present disclosure, splicing manners of code streams of different coding units are largest coding unit (LCU)-level splicing manners, and where acquiring the to-be-parsed code stream of the current coding unit according to the permission level of the user, the permission level of the current coding unit, and at least one of the start code or the end code of the code stream with the permission level of the current coding unit includes: reading a start position of a code stream with a non-lowest permission level, and at least one of a position of a start code of a next LCU and/or a position of an end code of a current LCU; and according to the permission level of the user and the permission level of the current coding unit, in response to the current coding unit being a first coding unit under a current permission level of the current LCU, deriving a start position of a code stream of the current coding unit based on at least one of the position of the end code of the current LCU or the position of the start code of the next LCU, and a start code of a code stream under a current permission level or length information of a code stream under a previous permission level of the current permission level; otherwise, directly acquiring the start position of the code stream of the current coding unit, so that the to-be-parsed code stream is parsed, and after completion of parsing. a start position of the code stream with the permission level corresponding to the current coding unit is updated.

In an embodiment of the present disclosure, acquiring the to-be-parsed code stream of the current coding unit according to the permission level of the user, the permission level of the current coding unit, and at least one of the start code or the end code of the code stream with the permission level of the current coding unit includes: in response the permission level of the current coding unit being a non-lowest permission level and the permission level of the current coding unit being not equal to a permission level of a previous coding unit, acquiring the start code of the code stream with the permission level of the current coding unit, or an end code of the previous coding unit, or a length of a code stream of the previous coding unit, and deriving a start position of a code stream of the current coding unit according to the start code of the code stream with the permission level of the current coding unit, or the end code of the previous coding unit, or the length of the code stream of the previous coding unit, and a start position of the code stream of the previous coding unit; otherwise, deriving the start position of the code stream of the current coding unit according to the start position of the code stream of the previous coding unit.

In an embodiment of the present disclosure, when the permission level of the user is less than the permission level of the current coding unit, the code stream with the permission level of the current coding unit is not decoded, and code streams without a permission level are decoded, to obtain the reconstructed image block of the current coding unit.

In an embodiment of the present disclosure, when the permission level of the user is less than the permission level of the current coding unit, the code stream with the permission level of the current coding unit is not decoded, and a fixed image block or image block information of coding units around the current coding unit with a permission level less than or equal to the permission level of the current coding unit is used to derive the reconstructed image block of the current coding unit.

The present disclosure further provides an encoding method, including: acquiring a to-be-encoded frame image, and determining position information of regions with different permission levels in the to-be-encoded frame image; dividing the to-be-encoded frame image into coding units based on the position information, where each of the coding units corresponds to a region with only one permission level; and for related encoding coefficients corresponding to coding units in the regions with different permission levels, acquiring entropy encoders corresponding to the permission levels, respectively encoding the related encoding coefficients to obtain different code streams, and splicing the different code streams, where the code streams are placed to internal code stream information of a current frame, and the code stream information of the current frame includes a code stream with a lowest permission level and at least one code stream with a permission level greater than the lowest permission level; when a permission level of a user is greater than or equal to a permission level of a current coding unit, a to-be-parsed code stream of the current coding unit is equal to a code stream with the permission level of the current coding unit, and a to-be-parsed code stream with a non-lowest permission level includes a code stream with a lowest permission level and at least one code stream with a permission level greater than the lowest permission level.

In an embodiment of the present disclosure, when the coding units obtained after dividing correspond to regions with multiple permission levels, the coding units are further divided, until the coding units obtained after further dividing have been divided to a preset division depth, or the coding units obtained after further dividing correspond to regions with only one permission level.

In an embodiment of the present disclosure, after the coding units are divided to the preset division depth, in response to the coding units obtained after dividing still corresponding to regions with multiple permission levels, the permission levels of the regions corresponding to the coding units obtained after dividing are adjusted to non-lowest permission levels of the regions.

In an embodiment of the present disclosure, the to-be-encoded frame image are divided into the coding units based on the position information, and in response to each of the coding units obtained after dividing corresponding to the region with only one permission level, the coding unit is allowed or disallowed to be further divided.

In an embodiment of the present disclosure, when the coding unit corresponding to the region with only one permission level is allowed to be further divided, the coding unit is further divided in different sizes.

In an embodiment of the present disclosure, respectively encoding the related encoding coefficients corresponding to the coding units in the regions with different permission levels to obtain the different code streams includes: using different entropy encoders to respectively encode the related encoding coefficients corresponding to the coding units in the regions with different permission levels to obtain the different code streams.

In an embodiment of the present disclosure, using the different entropy encoders to respectively encode the related encoding coefficients corresponding to the coding units in the regions with different permission levels to obtain the different code streams includes: using the different entropy encoders and acquiring a set of contexts to respectively encode the related encoding coefficients corresponding to the coding units in the regions with different permission levels to obtain the different code streams.

In an embodiment of the present disclosure, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

In an embodiment of the present disclosure, a coding unit with a non-lowest permission level uses a first set of contexts of a coding unit with a lowest permission level as second set of contexts thereof, only the coding unit with the lowest permission level is able to update its first set of contexts, and the coding unit with the non-lowest permission level is not able to update any context.

In an embodiment of the present disclosure, in response to the permission level of the current coding unit being the same as or higher than a permission level of a previous coding unit, contexts of the previous coding unit are updated, and in response to the permission level of the current coding unit being lower than the permission level of the previous coding unit, the contexts of the previous coding unit are initialized.

In an embodiment of the present disclosure, current coding units with different permission levels each use a set of contexts, and current coding units with a same permission level share a set of contexts.

In an embodiment of the present disclosure, using the different entropy encoders to respectively encode the related encoding coefficients corresponding to the coding units in the regions with different permission levels to obtain the different code streams includes:
using different entropy encoders to respectively encode the related encoding coefficients corresponding to the coding units in the regions with different permission levels and adjustment parameters and correspondingly encode the related encoding coefficients and the adjustment parameters into different code streams.

In an embodiment of the present disclosure, the adjustment parameters include quantization step adjustment parameters, and the quantization step adjustment parameters of the coding units in the regions with different permission levels are encoded into a code stream corresponding to a coding unit in a region with a lowest permission level.

In an embodiment of the present disclosure, splicing the different code streams includes: splicing the different code streams in a preset splicing manner, where the preset splicing manner includes a frame-level splicing manner, a slice-level splicing manner, a largest coding unit (LCU)-level splicing manner, or a coding unit (CU)-level splicing manner.

In an embodiment of the present disclosure, splicing the different code streams in the frame-level splicing manner includes: at a position of an end code of the current frame and/or a position of a start code of a next frame, according to a permission level of a coding unit with a non-lowest permission level, splicing and placing a code stream with the permission level corresponding to the coding unit with the non-lowest permission level, and/or a code stream with length information of the code stream corresponding to the coding unit with the non-lowest permission level.

In an embodiment of the present disclosure, splicing the different code streams in the frame-level splicing manner includes: at a position of an end code of the current frame and/or a position of a start code of a next frame, according to a permission level of a coding unit with a non-lowest permission level, splicing and placing a code stream with the permission level corresponding to the coding unit with the non-lowest permission level and a start code and/or an end code of the code stream with the permission level of the coding unit with the non-lowest permission level, and/or a code stream with length information of the code stream corresponding to the coding unit with the non-lowest permission level.

In an embodiment of the present disclosure, splicing the different code streams in the slice-level splicing manner includes: at a start position of a code stream with a non-lowest permission level and a position of a start code of a next slice and/or a position of an end code of a current slice, splicing and placing a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level.

In an embodiment of the present disclosure, splicing the different code streams in the LCU-level splicing manner includes: at a start position of a code stream with a non-lowest permission level and a position of a start code of a next LCU and/or a position of an end code of a current LCU, splicing and placing a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level.

In an embodiment of the present disclosure, splicing the different code streams in the CU-level splicing manner includes: if the permission level of the current coding unit is not equal to a permission level of a previous coding unit, encoding and then writing a start code of a code stream of the current coding unit and/or an end code of the previous coding unit and/or length information of a code stream corresponding to the previous coding unit into the code stream of the current coding unit.

The present disclosure further provides a decoding apparatus, including: a first acquiring module, configured to acquire a permission level of a user and a permission level of a current coding unit; a second acquiring module, configured to acquire a to-be-parsed code stream of the current coding unit according to the permission level of the user and the permission level of the current coding unit, where the code stream is acquired from internal code stream information of a current frame, and the code stream information of the current frame includes a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level includes a code stream with a lowest permission level and at least one code stream with a permission level greater than the lowest permission level; and a parsing module, configured to acquire an entropy decoder corresponding to permission levels according to the permission level of the user, the permission level of the current coding unit, and a corresponding code stream, and parse the to-be-parsed code stream to obtain a reconstructed image block of the current coding unit.

The present disclosure further provides an encoding apparatus, including: a third acquiring module, configured to acquire a to-be-encoded frame image, and determine position information of regions with different permission levels in the to-be-encoded frame image; a dividing module, configured to divide the to-be-encoded frame image into coding units based on the position information, where each of the coding units corresponds to a region with only one permission level; and an encoding module, configured to, for related encoding coefficients corresponding to coding units in the regions with different permission levels, acquire entropy encoders corresponding to the permission levels, respectively encode the related encoding coefficients to obtain different code streams, and splice the different code streams, where the code streams are placed to internal code stream information of a current frame, and the code stream information of the current frame includes a code stream with a lowest permission level and at least one code stream with a permission level greater than the lowest permission level; when a permission level of a user is greater than or equal to a permission level of a current coding unit, a to-be-parsed code stream of the current coding unit is equal to a code stream with the permission level of the current coding unit, and a to-be-parsed code stream with a non-lowest permission level includes a code stream with a lowest permission level and at least one code stream with a permission level greater than the lowest permission level.

The present disclosure further provides a decoding device, which is an entity node device. The decoding device includes: a memory, a processor, and a program of the decoding method stored in the memory and runnable on the processor, where the program of the decoding method is executed by the processor to implement the decoding method as described above.

In order to achieve the above purpose, a storage medium is further provided, having a decoding program stored therein, where the decoding program is executed by a processor to implement the decoding method as described above.

The present disclosure further provides an encoding device, which is an entity node device. The encoding device includes: a memory, a processor, and a program of the encoding method stored in the memory and runnable on the processor, where the program of the encoding method is executed by the processor to implement the encoding method as described above.

In order to achieve the above purpose, a storage medium is further provided, having an encoding program stored therein, where the encoding program is executed by a processor to implement the encoding method as described above.

The present disclosure provides encoding and decoding methods, apparatuses and devices and storage media. Compared with the related art where encoding and decoding at least two-path videos for users with different permission levels result in low efficiency and large resource consumption, in the present disclosure, the code stream is acquired from the internal code stream information of the current frame, and the code stream information of the current frame includes the code stream with the lowest permission level and the at least one code stream with the permission level greater than the lowest permission level, that is, all code streams with different permission levels are one-path code streams instead of multi-path code streams (which avoids low efficiency and large consumption caused by decoding multi-path code streams at the same time). In addition, in the embodiments, the to-be-parsed code stream of the current coding unit is acquired according to the permission level of the user and the permission level of the current coding unit, and when the permission level of the user is greater than or equal to the permission level of the current coding unit, the to-be-parsed code stream is equal to the code stream with the permission level of the current coding unit. Therefore, a user with a low permission level cannot correctly decode code stream contents of a coding unit with a higher permission level, and a user with a higher permission level can correctly parse a code stream of a coding unit with a low permission level (which meets parsing requirements of a user with more than two permission levels). After the to-be-parsed code stream is determined, the entropy decoder corresponding to the permission levels is acquired according to the permission level of the user, the permission level of the current coding unit, and the corresponding code stream (entropy decoders corresponding to different permission levels are different, meeting encoding requirements in different cases, which can effectively protect contents with different permission levels), and the to-be-parsed code stream is parsed to obtain the reconstructed image block of the current coding unit, so that requirements of users with respective permission levels for acquiring their corresponding contents are met.

### BRIEF DESCRIPTION OF THE DRAWINGS

FIG. 1 is a schematic flowchart of a first embodiment of a decoding method according to the present disclosure;

FIG. 2 is a schematic flowchart of a first embodiment of an encoding method according to the present disclosure;

FIG. 3 is a schematic structural diagram of a device in a hardware running environment involved in an embodiment solution according to the present disclosure;

FIG. 4 is a schematic diagram of a first scenario involved in encoding and decoding methods according to the present disclosure;

FIG. 5 is a schematic diagram of a first scenario involved in a decoding method according to the present disclosure;

FIG. 6 is a composition diagram of a code stream structure involved in an encoding method according to the present disclosure;

FIG. 7 is composition of a code stream in image data involved in an encoding method according to the present disclosure;

FIG. 8 is a schematic diagram of a second scenario involved in a decoding method according to the present disclosure;

FIG. 9 is a schematic diagram of a third scenario involved in a decoding method according to the present disclosure;

FIG. 10 is a schematic diagram of a fourth scenario involved in a decoding method according to the present disclosure.

### DETAILED DESCRIPTION OF THE EMBODIMENTS

It should be understood that the specific embodiments described herein are merely used to explain the present disclosure, but are not used to limit this application.

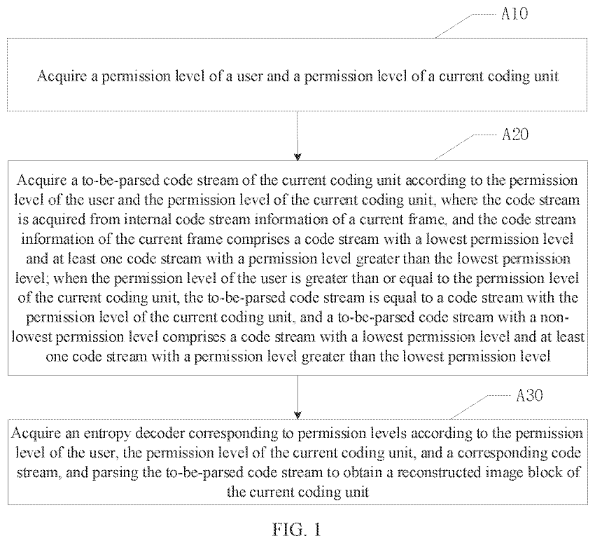

An embodiment of the present disclosure provides a decoding method. In the embodiment of the decoding method according to the present disclosure, with reference to FIG. 1, the method includes the following steps A1 to A3.

At step A1, a permission level of a user and a permission level of a current coding unit are acquired.

At step A2, a to-be-parsed code stream of the current coding unit is acquired according to the permission level of the user and the permission level of the current coding unit, where the code stream is acquired from internal code stream information of a current frame, and the code stream information of the current frame includes a code stream with a lowest permission level and at least one code stream with a permission level greater than the lowest permission level: when the permission level of the user is greater than or equal to the permission level of the current coding unit, the to-be-parsed code stream is equal to a code stream with the permission level of the current coding unit, and a to-be-parsed code stream with a non-lowest permission level includes a code stream with a lowest permission level and at least one code stream with a permission level greater than the lowest permission level.

At step A3, an entropy decoder corresponding to permission levels is acquired according to the permission level of the user, the permission level of the current coding unit, and a corresponding code stream, and the to-be-parsed code stream is parsed to obtain a reconstructed image block of the current coding unit.

In this embodiment, the code stream is acquired from the internal code stream information of the current frame, and the code stream information of the current frame includes the code stream with the lowest permission level and the at least one code stream with the permission level greater than the lowest permission level, that is, all code streams with different permission levels are one-path code streams instead of multi-path code streams. In addition, in this embodiment, the to-be-parsed code stream of the current coding unit is acquired according to the permission level of the user and the permission level of the current coding unit, and when the permission level of the user is greater than or equal to the permission level of the current coding unit, the to-be-parsed code stream is equal to the code stream with the permission level of the current coding unit. Therefore, a user with a low permission level cannot correctly decode code stream contents of a coding unit with a higher permission level, and a user with a higher permission level can correctly parse a code stream of a coding unit with a low permission level. After the to-be-parsed code stream is determined, the entropy decoder corresponding to the permission levels is acquired according to the permission level of the user, the permission level of the current coding unit, and the corresponding code stream (entropy decoders corresponding to different permission levels are different, meeting encoding requirements in different cases, which can effectively protect contents with different permission levels), and the to-be-parsed code stream is parsed to obtain the reconstructed image block of the current coding unit.

As an example, the permission level of the current coding unit is accurately determined from an image header of the current frame or internal code stream information with a non-permission level of the current frame, so that users with different permission levels are provided with a basis to correctly parse code streams corresponding to different permission levels.

As an example, since the current coding unit corresponds to one permission level, not only confidentiality of an image can be prevented from being damaged (a large image block with a non-lowest permission level corresponds to a coding unit with a low permission level, so that a user with a low permission level can acquire contents of an image block with a high permission level), but also a coding unit with a lowest permission level can be prevented from being not effectively restored to a reconstructed image block (a large image block with a lowest permission level corresponds to a coding unit with a non-lowest permission level, resulting in that the coding unit with the lowest permission level cannot be effectively restored to the reconstructed image block).

As an example, in a small number of cases, code streams with multiple permission levels corresponding to a coding unit acquired from the image header of the current frame are not correspondingly changed according to permission levels of different code streams in the internal code stream information of the current frame. Therefore, when the permission level of the current coding unit is acquired from the image header of the current frame, if it is determined that the current coding unit corresponds to a plurality of permission levels, a highest permission level in the plurality of permission levels is used as the permission level of the current coding unit, so that the permission level of the current coding unit (corresponding to permission level division of different code streams in the internal code stream information of the current frame) is accurately determined.

As an example, the to-be-parsed code stream of the current coding unit is acquired according to the permission level of the user and the permission level of the current coding unit, where the to-be-parsed code stream includes a related encoding coefficient code stream of the current coding unit and an adjustment parameter code stream. Therefore, adjustment requirements of corresponding encoding coefficients of different coding units are met.

As an example, a quantization step adjustment parameter code stream is acquired from code streams with a lowest permission level, so that different coding units can perform corresponding adjustment.

As an example, the entropy decoder corresponding to the permission levels is acquired, a set of contexts is acquired, and the to-be-parsed code stream is parsed, which can adapt to different decoding scenarios and improve decoding efficiency.

As an example, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated. Since, before the second set of contexts is obtained, the updated first set of contexts is first copied and is re-updated, multiple sets of contexts do not need to be maintained, which saves resources.

As an example, context-based adaptive binary arithmetic coding CABAC is used to encode and decode different syntax elements. When the context-based adaptive binary arithmetic coding CABAC is used to encode and decode the different syntax elements, a table with updated probability parameters is preset, and variables that need to be updated each time are derived through a context model (contexts). After the variables are obtained, next index is performed according to the current context model.

As an example, by constructing the context model, redundancy between symbols can be reduced, and encoding efficiency can be improved. Since there is correlation between encoding symbols, context information provided by a previous encoding symbol for a current encoding element can be used to select a suitable probability.

As an example, when contexts are updated, it may be selected to update only contexts of some syntax elements corresponding to the current coding unit or contexts of all syntax elements corresponding to the current coding unit, so that different decoding requirements are met.

As an example, a coding unit with a non-lowest permission level uses a first set of contexts of a coding unit with a lowest permission level as its second set of contexts, only the coding unit with the lowest permission level can update its first set of contexts, and the coding unit with the non-lowest permission level cannot update any context. In this embodiment, different encoding requirements can be met.

As an example, if the permission level of the current coding unit is the same as or higher than a permission level of a previous coding unit, contexts of the previous coding unit are updated, and if the permission level of the current coding unit is lower than the permission level of the previous coding unit, the contexts of the previous coding unit are initialized. In this embodiment, only one set of contexts is stored, which facilitates to save resources.

As an example, current coding units with different permission levels each use a set of contexts, and current coding units with a same permission level share a set of contexts. Sharing only one set of contexts can save resources.

As an example, the to-be-parsed code stream of the current coding unit is acquired according to the permission level of the user, the permission level of the current coding unit, and a start code and/or an end code of a code stream with the permission level of the current coding unit, which facilitates to find the to-be-parsed code stream of the current coding unit.

As an example, if splicing manners of code streams of different coding units are frame-level splicing manners, a start position of the code stream with the permission level corresponding to the current coding unit or length information of a code stream with a previous permission level is acquired based on a position of an end code of the current frame and/or a position of a start code of a next frame, so that the to-be-parsed code stream is accurately acquired and parsed.

As an example, if splicing manners of code streams of different coding units are slice-level splicing manners, a start position of the code stream with the permission level corresponding to the current coding unit or length information of a code stream with a previous permission level is acquired based on a start position of a code stream with a non-lowest permission level, and a position of a start code of a next slice and/or a position of an end code of a current slice, so that the to-be-parsed code stream is accurately acquired and parsed.

As an example, if splicing manners of code streams of different coding units are largest coding unit (LCU)-level splicing manners, a start position of the code stream with the permission level corresponding to the current coding unit or length information of a code stream with a previous permission level is acquired based on a start position of a code stream with a non-lowest permission level, and a position of a start code of a next LCU and/or a position of an end code of a current LCU, so that the to-be-parsed code stream is accurately acquired and parsed.

As an example, a start position of the code stream with the permission level corresponding to the current coding unit or length information of a code stream with a current permission level is acquired based on a start position of a code stream with a lowest permission level, and a position of a start code of a next CU (coding unit) and/or a position of an end code of a current cu, so that the to-be-parsed code stream is accurately acquired and parsed.

As an example, when the permission level of the user is less than the permission level of the current coding unit, the code stream with the permission level of the current coding unit is not decoded, but code streams without a permission level are decoded, and a fixed image block or default image block information is used to obtain the reconstructed image block of the current coding unit.

As an example, an application scenario of this embodiment is the following scenario.

In a monitoring scenario in which vehicles in a parking lot are monitored, the current coding unit is a coding unit corresponding to a license plate image block in a monitoring image (a permission level of the current coding unit is higher than a permission level of a coding unit corresponding to other non-license plate image block), or the current coding unit is a coding unit corresponding to other non-license plate image block in the monitoring image (a permission level of the current coding unit is lower than a permission level of a coding unit corresponding to a license plate image block). For different users, for example, a common user (with a lowest permission level), only a code stream corresponding to a coding unit corresponding to other non-license plate image block can be acquired and parsed, while, for a non-common user, a code stream corresponding to a coding unit corresponding to other non-license plate image block and a code stream corresponding to a coding unit corresponding to a license plate image block can be acquired, and code streams of different coding units are same-path code streams.

As an example, in an authentication scenario in which qualification is authenticated, the current coding unit is a coding unit corresponding to an identity card image block in an authentication image (a permission level of the current coding unit is higher than a permission level of other coding unit), or the current coding unit is a coding unit corresponding to a human face image block in the authentication image (a permission level of the current coding unit is lower than a permission level of a coding unit corresponding to the identity card image block and higher than a permission level of a coding unit corresponding to other non-identity card image block), or the current coding unit is a coding unit corresponding to other image block in the authentication image (a permission level of the current coding unit is lowest). For different users, for example, a user with a third permission level (which is a lowest permission level), only a code stream corresponding to a coding unit corresponding to other image block (non-human face or non-identity card image block) can be acquired and parsed; for a user with a second permission level (which is a non-lowest permission level), a code stream corresponding to a coding unit corresponding to a human face image block and a code stream corresponding to a coding unit corresponding to other image block (non-human face or non-identity card image block) can be acquired; for a user with a first permission level (which is a highest permission level), code streams corresponding to coding units corresponding to all image blocks can be acquired, and code streams of different coding units are same-path code streams.

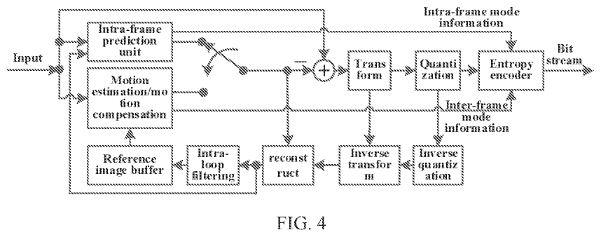

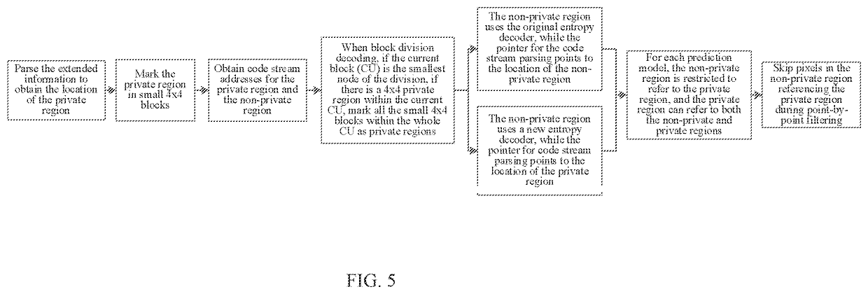

FIG. 4 corresponds to a common video encoding framework. The encoding framework is applicable to the present disclosure, and includes modules such as a prediction module, a transform module, a quantization module, an entropy encoding module, and a filtering module. The modules will be briefly introduced.
(1) The prediction module includes intra-frame prediction and inter-frame prediction, where the intra-frame prediction is prediction performed by using reconstructed pixels around a current block, to remove space redundancy; the inter-frame prediction is prediction performed by using reconstructed pixels in a time-domain reference frame, to remove time redundancy.
(2) The transform module linearly maps residual information in a space domain to a transform domain (for example, a frequency domain), with the goal of enabling energy to be more concentrated and removing frequency domain correlation of signals. A theoretical transform matrix is reversible, and no signal loss is brought.
(3) The quantization module involves a “many-to-one” mapping process, which is irreversible and brings signal loss. Its advantage is that a value range of a signal can be greatly reduced, and thereby an encoder can give good approximation of an original signal by using a small number of symbols, improving a compression rate.
(4) The entropy encoding module converts a series of element symbols (such as transform coefficients and mode information) used to represent a video sequence into a binary code stream based on a lossless encoding scheme of an information entropy principle, to remove statistical redundancy of these video element symbols.
(5) The filtering module enhances a reconstructed image, with the goal of enabling the reconstructed image to be closer to an original image, while reducing the influence of a blocking effect and a ringing effect, and improving the quality of the reconstructed image.

The above introduction is given by taking encoding as an example. A video decoding process is relative to a video encoding process, that is, video decoding usually includes processes such as an entropy decoding process, a prediction process, an inverse quantization process, an inverse transform process, and a filtering process. An implementation principle of each process is the same as or similar to that of entropy encoding. The filtering process includes deblocking filtering, sample adaptive compensation filtering, adaptive loop filtering, and neural network-based filtering.

In this embodiment, the specific steps include the following steps.

At step A10, a permission level of a user and a permission level of a current coding unit are acquired.

As an example, for the current coding unit (a decoding unit), the permission level of the user may be directly acquired based on attribute information of the user, where the permission level of the user may be a first permission level, a second permission level, a third permission level, or the like (a user with a lowest (permission) level, or a user with a non-lowest (permission) level), which is not specifically limited.

As an example, the permission level of the current coding unit may be a lowest permission level (a third permission level), or a non-lowest permission level (a coding unit with the non-lowest permission level may have more than one permission level, including a first permission level, a second permission level, and the like).

The step of acquiring the permission level of the current coding unit includes the following step A11.

At step A11, the permission level of the current coding unit is acquired from an image header of a current frame or internal code stream information with a non-permission level of the current frame.

As an example, the current coding unit directly reads its permission level from the image header of the current frame (or based on a slice header or an LCU header, that is, when a current slice/LCU is encoded, permission level information in the current slice/LCU is first acquired from a code stream, and m*n is used as a minimum unit to mark; if there is more than one permission level in the m*n, a current m*n block is marked as having a highest permission level in the current m*n); or the current coding unit acquires its permission level when decoding the internal code stream information with a non-permission level (determining while decoding).

As an example, the current coding unit has only one permission level.

As an example, the permission level of the current coding unit is only a first permission level or a second permission level.

As an example, since the current coding unit corresponds to one permission level, not only confidentiality of an image can be prevented from being damaged, but also a coding unit with a lowest permission level can be prevented from being not effectively restored to a reconstructed image block (a large image block with a lowest permission level corresponds to a coding unit with a non-lowest permission level, resulting in that the coding unit with the lowest permission level cannot be effectively restored to the reconstructed image block, and a user with a lowest permission level cannot acquire contents of an image block with its corresponding permission level).

As an example, a permission level of a coding unit is determined from the image header of the current frame, and meanwhile, a code stream of the current coding unit is obtained by parsing the internal code stream information of the current frame. If it is determined that the current coding unit corresponds to a code stream with a plurality of permission levels, a highest permission level in the plurality of permission levels is used as the permission level of the current coding unit (corresponding to permission levels of different code streams in the internal code stream information of the current frame). Here, for image header information and coding unit division information, code streams involved therein are placed in a lowest permission level.

As an example, in subsequent decoding, if the permission level of the coding unit determined from the image header of the current frame corresponds to a code stream with a second permission level and a third permission level (which is a lowest permission level), the permission level of the current coding unit is the second permission level.

As an example, that the current coding unit acquires its permission level when decoding the internal code stream information of the current frame (determining while decoding) refers to: if only a number of permission levels existing in the entire frame, instead of a specific permission level of the current coding unit, is acquired based on the image header, when the internal code stream information of the current frame is parsed, the permission level of the current coding unit is acquired (determining while decoding), and now, the permission level of the current coding unit is acquired based on the internal code stream information of the current frame.

As an example, the coding unit in this embodiment may be, for example, an LCU (largest coding unit/macroblock), a PU (prediction unit) or a TU (transform unit).

Whether a function of multiple permission levels of a user is enabled is parsed from a code stream, and if the function of the multiple permission levels of the user is enabled, the code stream information of the current frame (i.e., the internal code stream information of the current frame) includes a code stream with a lowest permission level and at least one code stream with a permission level greater than the lowest permission level; otherwise, the code stream information of the current frame includes only the code stream with the lowest permission level.

At step A20, a to-be-parsed code stream of the current coding unit is acquired according to the permission level of the user and the permission level of the current coding unit, where the code stream is acquired from internal code stream information of a current frame, and the code stream information of the current frame includes a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level includes a code stream with a lowest permission level and at least one code stream with a permission level greater than the lowest permission level.

As an example, the to-be-parsed code stream is acquired from the internal code stream information of the current frame, and the code stream information of the current frame includes the code stream with the lowest permission level and the at least one code stream with the permission level greater than the lowest permission level, that is, for users with different permission levels, to-be-parsed code streams corresponding to their permission levels are obtained by parsing same-path code streams (the same-path code streams include a code stream with a lowest permission level and at least one code stream with a permission level greater than the lowest permission level), instead of parsing a certain-path code stream for users with a lowest permission level and parsing another-path code stream for users with a non-lowest permission level.

As an example, the to-be-parsed code stream of the current coding unit is acquired according to the permission level of the user and the permission level of the current coding unit, where, when the permission level of the user is greater than or equal to the permission level of the current coding unit, the to-be-parsed code stream is equal to the code stream with the permission level of the current coding unit, and the to-be-parsed code stream with the non-lowest permission level includes the code stream with the lowest permission level and the at least one code stream with the permission level greater than the lowest permission level. A user with a lowest permission level can parse the code stream with the lowest permission level, but cannot parse the code stream with the non-lowest permission level.

As an example, when the permission level of the user is less than the permission level of the current coding unit, the code stream with the permission level of the current coding unit is not decoded, and code streams without a permission level are decoded, to obtain a reconstructed image block of the current coding unit.

As an example, a code stream without a permission level is placed at a preset position of a code stream structure of the current frame, so that the current coding unit acquires the code stream without the permission level from the preset position, and decodes the code stream.

As an example, a code stream without a permission level is placed before an end code of a frame and after a code stream with a non-lowest permission level.

As an example, when the permission level of the user is less than the permission level of the current coding unit, the code stream with the permission level of the current coding unit is not decoded, and a fixed image block or image block information of coding units around the current coding unit with a permission level less than or equal to the permission level of the current coding unit is used to derive the reconstructed image block of the current coding unit.

As an example, when the permission level of the user is less than the permission level of the current coding unit, a fixed image block (default) is used as the reconstructed image block of the current coding unit.

As an example, when the permission level of the user is less than the permission level of the current coding unit, image block information of coding units around the current coding unit with a permission level less than or equal to the permission level of the current coding unit is used to derive the reconstructed image block of the current coding unit.

As an example, when the permission level of the user is less than the permission level of the current coding unit, one or more pieces of image block information of coding units around the current coding unit is used to derive the reconstructed image block of the current coding unit, where the permission level of the coding units corresponding to the one or more pieces of image block information is less than or equal to the permission level of the current coding unit.

As an example, when the reconstructed image block of the current coding unit is derived, if the permission level of the coding units corresponding to the one or more pieces of image block information is greater than the permission level of the current coding unit, the image block information is not referred to.

As an example, the step of acquiring the to-be-parsed code stream of the current coding unit according to the permission level of the user and the permission level of the current coding unit includes the following steps A21 and A22.

At step A21, the to-be-parsed code stream of the current coding unit is acquired according to the permission level of the user and the permission level of the current coding unit, where the to-be-parsed code stream includes a related encoding coefficient code stream of the current coding unit and an adjustment parameter code stream.

As an example, the to-be-parsed code stream further includes an adjustment parameter code stream, where adjustment parameters may be QPs (quantization parameters), and a permission level of the adjustment parameter code stream also corresponds to the permission level of the current coding unit.

In an example, related encoding coefficients include residual information, prediction mode information, etc.

The adjustment parameter code stream includes a quantization step adjustment parameter code stream, and the step of acquiring the to-be-parsed code stream of the current coding unit according to the permission level of the user and the permission level of the current coding unit includes:

At step A22, a to-be-parsed related encoding coefficient code stream of the current coding unit is acquired according to the permission level of the user and the permission level of the current coding unit.

The quantization step adjustment parameter code stream is acquired from code streams with a lowest permission level.

As an example, the quantization step adjustment parameter code stream is placed in the code streams with the lowest permission level, so that, for the current coding unit (regardless of whether it has a lowest permission level or a non-lowest permission level), the quantization step adjustment parameter code stream can be acquired from the code streams with the lowest permission level.

At step S30, an entropy decoder corresponding to permission levels is acquired according to the permission level of the user, the permission level of the current coding unit, and a corresponding code stream, and the to-be-parsed code stream is parsed to obtain a reconstructed image block of the current coding unit.

The entropy decoder corresponding to the permission levels is acquired according to the permission level of the user, the permission level of the current coding unit, and the corresponding code stream, that is, different permission levels correspond to different entropy decoders.

After an entropy decoder with the permission level of the current coding unit is obtained, the to-be-parsed code stream is parsed based on the entropy decoder to obtain the reconstructed image block of the current coding unit, so that the user acquires a reconstructed image block corresponding to the permission level of the user.

Taking the figure as an example, the overall embodiment will be described.

After the permission level of the user is acquired, the current coding unit can acquire N different permission levels on the whole in a current image based on a frame-level image header, and meanwhile, can acquire specific division of the different permission levels, so that the permission level of the current coding unit can be acquired (if it is determined that the current coding unit corresponds to code streams with a plurality of permission levels, a highest permission level in the plurality of permission levels is used as the permission level of the current coding unit).

As an example, the current coding unit acquires its permission level based on code stream information in a decoding process (where an encoding end has divided regions with different permission levels in a current frame image by using m*n as a minimum unit, and thereafter transmits a corresponding code stream to a decoding end; each m*n includes only one permission level, and if, in fact, m*n small blocks correspond to different permission levels, a permission level of current m*n is correspondingly a highest permission level. m*n is also used to mark in the decoding end, and when information about regions with a permission level of an overall frame (a permission level of a coding unit) is acquired from an image header, m*n needs to be used as a minimum unit to mark. As an example, a size of m*n may be 4×4 or 8×8 or 16×16 or the like).

As an example, if the permission level of the user is greater than or equal to the permission level of the current coding unit, the to-be-parsed code stream is equal to the code stream with the permission level of the current coding unit (including a related encoding coefficient code stream and an adjustment parameter code stream).

In this embodiment, the code stream is acquired from the internal code stream information of the current frame, and the code stream information of the current frame includes the code stream with the lowest permission level and the at least one code stream with the permission level greater than the lowest permission level, that is, all code streams with different permission levels are one-path code streams instead of multi-path code streams. In addition, in this embodiment, the to-be-parsed code stream of the current coding unit is acquired according to the permission level of the user and the permission level of the current coding unit, and when the permission level of the user is greater than or equal to the permission level of the current coding unit, the to-be-parsed code stream is equal to the code stream with the permission level of the current coding unit. Therefore, a user with a low permission level cannot correctly decode code stream contents of a coding unit with a higher permission level, and a user with a higher permission level can correctly parse a code stream of a coding unit with a low permission level. After the to-be-parsed code stream is determined, the entropy decoder corresponding to the permission levels is acquired according to the permission level of the user, the permission level of the current coding unit, and the corresponding code stream (entropy decoders corresponding to different permission levels are different, meeting encoding requirements in different cases, which can effectively protect contents with different permission levels), and the to-be-parsed code stream is parsed to obtain the reconstructed image block of the current coding unit, so that requirements of users with respective permission levels for acquiring their corresponding contents are met.

Further, based on the first embodiment of the present disclosure, another embodiment of the application is provided, and in this embodiment, the step of acquiring the entropy decoder corresponding to the permission levels according to the permission level of the user, the permission level of the current coding unit, and the corresponding code stream, and parsing the to-be-parsed code stream includes the following step A31.

At step A31, the entropy decoder corresponding to the permission levels is acquired according to the permission level of the user, the permission level of the current coding unit, and the corresponding code stream, a set of contexts is acquired, and the to-be-parsed code stream is parsed.

As an example, an entropy decoder corresponding to permission levels is acquired according to the permission level of the user, the permission level of the current coding unit, and corresponding code stream, a set of contexts is acquired, and the to-be-parsed code stream is parsed.

As an example, respective coding units with different permission levels use different entropy decoders, with different entropy decoding states.

As an example, for the current coding unit, a separate entropy decoder corresponding to its permission level is used.

As an example, for the current coding unit, a separate entropy decoder corresponding to its permission level is used. In addition, a set of contexts is acquired, and the to-be-parsed code stream is parsed.

As an example, a coding unit with a non-lowest permission level uses a first set of contexts of a coding unit with a lowest permission level as its second set of contexts, only the coding unit with the lowest permission level can update its first set of contexts, and the coding unit with the non-lowest permission level cannot update any context.

As an example, if the permission level of the current coding unit is the same as or higher than a permission level of a previous coding unit, contexts of the previous coding unit are updated, and if the permission level of the current coding unit is lower than the permission level of the previous coding unit, the contexts of the previous coding unit are initialized.

As an example, current coding units with different permission levels each use a set of contexts, and current coding units with a same permission level share a set of contexts.

As an example, there include the following cases:
1) The permission level of the current coding unit is acquired, and when the current coding unit (with a lowest permission level) uses an entropy decoder to decode, its used contexts are a first set of contexts, where only the coding unit with a lowest permission level can update its corresponding contexts, i.e., the first set of contexts; when the current coding unit (with a non-lowest permission level) uses an entropy decoder to decode, its used contexts are a second set of contexts copied with the updated first set of contexts. In the case 1), correspondingly, only one set of contexts (the first set of contexts updated by the coding unit with the lowest permission level) needs to be stored.
2) As an example, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

Specifically, an entropy decoder corresponding to the coding unit with the lowest permission level uses contexts with a lowest permission level. For an entropy decoder corresponding to the coding unit with the non-lowest permission level, all updated contexts corresponding to a current lowest permission level are first copied. If it is allowed to update any context (the permission level of the current coding unit is higher than or equal to the permission level of the previous coding unit), all the acquired updated contexts are re-updated for use by the current coding unit to decode the corresponding to-be-parsed code stream.

After decoding the to-be-parsed code stream corresponding to the current coding unit is completed, the state of contexts is restored to a state of contexts corresponding to the coding unit with the lowest permission level. In 2), two sets of contexts (the contexts corresponding to the coding unit with the lowest permission level, and the contexts copied with the updated first set of contexts and re-updated) need to be stored, but the contexts corresponding to the coding unit with the lowest permission level can be correspondingly used by coding units with all permission levels.
3) If the permission level of the current coding unit is higher than or equal to the permission level of the previous coding unit, contexts updated by the previous coding unit are allowed to be updated; otherwise, the contexts updated by the previous coding unit are initialized.
4) Contexts are a set of contexts, instead of one context, that is, different syntaxes exist in entropy decoding, and some syntaxes correspond to separate contexts. Therefore, when the contexts are updated, only contexts of some syntax elements corresponding to the current coding unit or contexts of all syntax elements corresponding to the current coding unit can be updated.

In this embodiment, the entropy decoder corresponding to the permission levels is acquired according to the permission level of the user, the permission level of the current coding unit, and the corresponding code stream, a set of contexts is acquired, and the to-be-parsed code stream is parsed. Therefore, decoding efficiency is improved.

Further, based on the above embodiment of the present disclosure, another embodiment of the application is provided.

In this embodiment, the step of acquiring the to-be-parsed code stream of the current coding unit according to the permission level of the user and the permission level of the current coding unit includes the following step A23.

At step A23, the to-be-parsed code stream of the current coding unit is acquired according to the permission level of the user, the permission level of the current coding unit, and a start code and/or an end code of a code stream with the permission level of the current coding unit.

As an example, the to-be-parsed code stream of the current coding unit is acquired according to the permission level of the user, the permission level of the current coding unit, splicing manners of code streams, and the start code and/or the end code of the code stream with the permission level of the current coding unit.

As an example, a start position of a code stream of the current coding unit can be found according to a start code existing in a code stream between different permission levels, and the to-be-parsed code stream of the current coding unit is acquired.

As an example, a start position of a code stream of the current coding unit is found according to lengths of code streams with different permission levels, and the to-be-parsed code stream of the current coding unit is acquired.

As an example, FIG. 6 is a composition diagram of a code stream structure, and FIG. 7 is composition of a code stream in image data.

As an example, if splicing manners of code streams of different coding units are frame-level splicing manners,
the step of acquiring the to-be-parsed code stream of the current coding unit according to the permission level of the user, the permission level of the current coding unit, and the start code and/or the end code of the code stream with the permission level of the current coding unit includes: at least one of the following steps.

At step A231, a position of an end code of the current frame and/or a position of a start code of a next frame are read.

As an example, the current coding unit directly reads the position of the end code of the current frame and/or the position of the start code of the next frame.

At step A232, according to the permission level of the user and the permission level of the current coding unit, if the current coding unit is a first coding unit under a current permission level of the current frame, a start position of a code stream of the current coding unit is derived based on the position of the end code of the current frame and/or the position of the start code of the next frame, and a start code of a code stream under a current permission level or length information of a code stream under a previous permission level of the current permission level; otherwise (if the current coding unit is not a first coding unit under a current permission level of the current frame), the start position of the code stream of the current coding unit is directly acquired, where the current permission level refers to the permission level corresponding to the current coding unit, so that the to-be-parsed code stream is parsed, and after completion of parsing, a start position of the code stream with the permission level corresponding to the current coding unit is updated.

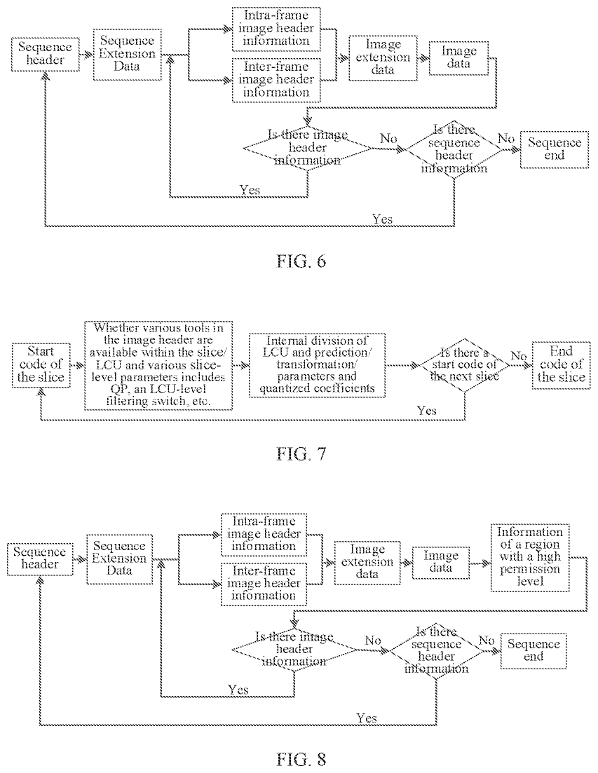

As an example, if the splicing manners of the code streams of different coding units are the frame-level splicing manners, that is, the current coding unit parses the code streams spliced in the frame-level splicing manners, newly added information of a region with a non-lowest permission level (information of a region with a high permission level) is as shown in FIG. 8. Now, according to the permission level of the user and the permission level of the current coding unit, if the current coding unit is the first coding unit under the current permission level of the current frame, the start position of the code stream of the current coding unit is derived based on the position of the end code of the current frame and/or the position of the start code of the next frame, and the start code of the code stream under the current permission level or the length information of the code stream under the previous permission level of the current permission level; otherwise, the start position of the code stream of the current coding unit is directly acquired (where the current permission level refers to the permission level corresponding to the current coding unit), so that the current to-be-parsed code stream is acquired, and after the completion of parsing, the start position of the code stream with the permission level corresponding to the current coding unit is updated, so that a coding unit with a next corresponding permission level can quickly acquire a start position of a code stream with the permission level corresponding to the coding unit.

If splicing manners of code streams of different coding units are slice-level splicing manners, the step of acquiring the to-be-parsed code stream of the current coding unit according to the permission level of the user, the permission level of the current coding unit, and the start code and/or the end code of the code stream with the permission level of the current coding unit includes the following steps.

At step A233, a start position of a code stream with a non-lowest permission level, and a position of a start code of a next slice and/or a position of an end code of a current slice are read.

At step A234, according to the permission level of the user and the permission level of the current coding unit, if the current coding unit is a first coding unit under a current permission level of the current slice, a start position of a code stream of the current coding unit is derived based on the position of the end code of the current slice and/or the position of the start code of the next slice, and a start code of a code stream under a current permission level or length information of a code stream under a previous permission level of the current permission level; otherwise (if the current coding unit is not a first coding unit under a current permission level of the current slice), the start position of the code stream of the current coding unit is directly acquired, so that the to-be-parsed code stream is parsed, and after completion of parsing, a start position of the code stream with the permission level corresponding to the current coding unit is updated.

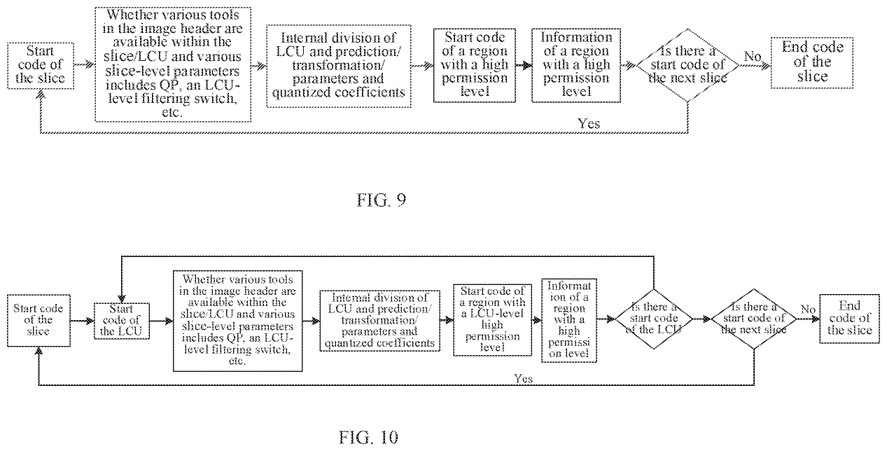

Slice-level splicing of code streams is as shown in FIG. 9 (in this embodiment, a start code of a region with a high permission level and information of the region with the high permission level are newly added), where a slice-level splicing manner of the code streams is as follows: a first segment is 0-order permission level information, and a second segment is 1-order permission level information (including a start code of the 1-order permission level information), until an n^{th} segment is (n−1)-order permission level information (including a start code of the (n−1)-order permission level information).

As an example, parsing the code streams spliced in the slice-level splicing manners is similar to that spliced in the frame-level splicing manners. If the current coding unit is the first coding unit under the current permission level of the current slice, the start position of the code stream of the current coding unit is derived based on the position of the end code of the current slice and/or the position of the start code of the next slice, and the start code of the code stream under the current permission level or the length information of the code stream under the previous permission level of the current permission level; otherwise, the start position of the code stream of the current coding unit is directly acquired, so that the to-be-parsed code stream is acquired and parsed, and after the completion of parsing, the start position of the code stream with the permission level corresponding to the current coding unit is updated, so that a next coding unit acquires a code stream with its corresponding permission level.

As an example, if splicing manners of code streams of different coding units are largest coding unit LCU-level splicing manners,

The step of acquiring the to-be-parsed code stream of the current coding unit according to the permission level of the user, the permission level of the current coding unit, and the start code and/or the end code of the code stream with the permission level of the current coding unit includes:

At step A235, a start position of a code stream with a non-lowest permission level, and a position of a start code of a next LCU and/or a position of an end code of a current LCU are read.

At step A236, according to the permission level of the user and the permission level of the current coding unit, if the current coding unit is a first coding unit under a current permission level of the current LCU, a start position of a code stream of the current coding unit is derived based on the position of the end code of the current LCU and/or the position of the start code of the next LCU, and a start code of a code stream under a current permission level or length information of a code stream under a previous permission level of the current permission level; otherwise (if the current coding unit is not a first coding unit under a current permission level of the current LCU), the start position of the code stream of the current coding unit is directly acquired, so that the to-be-parsed code stream is parsed, and after completion of parsing. a start position of the code stream with the permission level corresponding to the current coding unit is updated.

LCU-level splicing of code streams is as shown in FIG. 10 (in this embodiment, a start code of an LCU, a start code of a region with a high permission level, and information of the region with the high permission level are newly added).

As an example, parsing the code streams spliced in the LCU (largest decoding unit)-level splicing manners is similar to that spliced in the slice-level splicing manners. If the current coding unit is the first coding unit under the current permission level of the current LCU, the start position of the code stream of the current coding unit is derived based on the position of the end code of the current LCU and/or the position of the start code of the next LCU, and the start code of the code stream under the current permission level or the length information of the code stream under the previous permission level of the current permission level; otherwise, the start position of the code stream of the current coding unit is directly acquired, so that the to-be-parsed code stream is obtained, and after the completion of parsing, the start position of the code stream with the permission level corresponding to the current coding unit is updated.

The step of acquiring the to-be-parsed code stream of the current coding unit according to the permission level of the user, the permission level of the current coding unit, and the start code and/or the end code of the code stream with the permission level of the current coding unit includes the following step.

At step A237, if the permission level of the current coding unit is a non-lowest permission level and the permission level of the current coding unit is not equal to a permission level of a previous coding unit, the start code of the code stream with the permission level of the current coding unit, or an end code of the previous coding unit, or a length of a code stream of the previous coding unit is acquired, and a start position of a code stream of the current coding unit is derived according to the acquired start code of the code stream with the permission level of the current coding unit, or end code of the previous coding unit, or length of the code stream of the previous coding unit, and a start position of the code stream of the previous coding unit; otherwise (if the permission level of the current coding unit is not a non-lowest permission level and the permission level of the current coding unit is equal to a permission level of a previous coding unit), the start position of the code stream of the current coding unit is derived according to the start position of the code stream of the previous coding unit.

As an example, parsing the code streams spliced in the CU-level splicing manners is similar to that spliced in the LCU-level splicing manners. If the permission level of the current coding unit is the non-lowest permission level and the permission level of the current coding unit is not equal to the permission level of the previous coding unit, the start code of the code stream with the permission level of the current coding unit, or the end code of the previous coding unit, or the length of the code stream of the previous coding unit is acquired, and the start position of the code stream of the current coding unit is derived according to the acquired start code of the code stream with the permission level of the current coding unit, or end code of the previous coding unit, or length of the code stream of the previous coding unit, and the start position of the code stream of the previous coding unit; otherwise, the start position of the code stream of the current coding unit is derived according to the start position of the code stream of the previous coding unit, so that the to-be-parsed code stream is obtained and parsed, and after the completion of parsing, the start position of the code stream with the permission level corresponding to the current coding unit is updated, so that a next coding unit obtains and processes the updated start position.

In this embodiment, the to-be-parsed code stream of the current coding unit is acquired according to the permission level of the user, the permission level of the current coding unit, and the start code and/or the end code of the code stream with the permission level of the current coding unit. The to-be-parsed code stream of the current coding unit is quickly found, meeting parsing requirements.

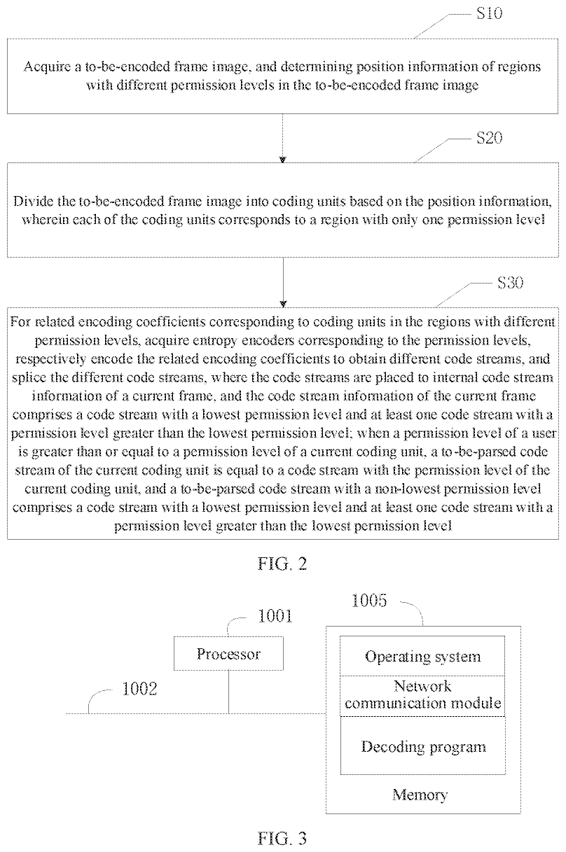

Based on the above embodiment, an embodiment provides an encoding method. As shown in FIG. 2, the encoding method includes the following steps S10 to S30.

At step S10, a to-be-encoded frame image is acquired, and position information of regions with different permission levels in the to-be-encoded frame image is determined.

At step S20, the to-be-encoded frame image are divided into coding units based on the position information.

Each coding unit obtained after dividing corresponds to a region with only one permission level.

At step S30, for related encoding coefficients corresponding to coding units in the regions with different permission levels, entropy encoders corresponding to the permission levels are acquired, the related encoding coefficients are respectively encoded to obtain different code streams, and the different code streams are spliced, where the code streams are placed to internal code stream information of a current frame, and the code stream information of the current frame includes a code stream with a lowest permission level and at least one code stream with a permission level greater than the lowest permission level; when a permission level of a user is greater than or equal to a permission level of a current coding unit, a to-be-parsed code stream of the current coding unit is equal to a code stream with the permission level of the current coding unit, and a to-be-parsed code stream with a non-lowest permission level includes a code stream with a lowest permission level and at least one code stream with a permission level greater than the lowest permission level.

In this embodiment, each coding unit obtained after dividing corresponds to the region with only one permission level; the code streams are placed to the internal code stream information of the current frame, and the code stream information of the current frame includes the code stream with the lowest permission level and the at least one code stream with the permission level greater than the lowest permission level; when the permission level of the user is greater than or equal to the permission level of the current coding unit, the to-be-parsed code stream of the current coding unit is equal to the code stream with the permission level of the current coding unit, and the to-be-parsed code stream with the non-lowest permission level includes the code stream with the lowest permission level and the at least one code stream with the permission level greater than the lowest permission level. Therefore, waste caused by encoding multi-path code streams is avoided.

In this embodiment, each coding unit obtained after dividing corresponds to the region with only one permission level. Not only confidentiality of a region with a non-lowest permission level is prevented from being damaged (a large region with a lowest permission level is classified to a region with a lowest permission level), but also a region with a lowest permission level can be prevented from being not effectively restored in decoding (the large region with the lowest permission level is classified to the region with the non-lowest permission level, resulting in that, when the region with the lowest permission level is restored, the large region cannot be referred to, and further, the region with the lowest permission level cannot be effectively restored).

As an example, in the encoding process of the present disclosure, when the coding units obtained after dividing correspond to regions with multiple permission levels, the coding units are further divided, until the coding units obtained after further dividing have been divided to a preset division depth, or the coding units obtained after further dividing correspond to regions with only one permission level. In this embodiment, the coding units will not be divided without limit, avoiding excessive resource or time consumption.

As an example, in the encoding process of the present disclosure, after the coding units are divided to the preset division depth, if the coding units obtained after dividing still correspond to regions with multiple permission levels, the permission levels of the regions corresponding to the coding units obtained after dividing are adjusted to highest permission levels of the regions. Therefore, it is convenient to enable code streams with different permission levels to correspond to users with corresponding permission levels.

As an example, the to-be-encoded frame image are divided into the coding units based on the position information, and if each coding unit obtained after dividing corresponds to the region with only one permission level, the coding unit is allowed or disallowed to be further divided, so that different encoding requirements are met.

As an example, when the coding unit corresponding to the region with only one permission level is allowed to be further divided, the coding unit is further divided in different sizes, so that different encoding requirements are met.

As an example, in the present disclosure, different entropy encoders are used to respectively encode the coding units in the regions with different permission levels, so that encoding requirements of the coding units in the regions with different permission levels are met.

As an example, the different entropy encoders are used and a set of contexts is acquired to respectively encode the related encoding coefficients corresponding to the coding units in the regions with different permission levels to obtain the different code streams, which can adapt to different encoding scenarios and improve encoding efficiency.

As an example, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated, so that resource waste caused by storing excessive contexts is avoided.

As an example, a coding unit with a non-lowest permission level uses a first set of contexts of a coding unit with a lowest permission level as its second set of contexts, only the coding unit with the lowest permission level can update its first set of contexts, and the coding unit with the non-lowest permission level cannot update any context. In this embodiment, resource waste can be avoided.

As an example, if the permission level of the current coding unit is the same as or higher than a permission level of a previous coding unit, contexts of the previous coding unit are updated, and if the permission level of the current coding unit is lower than the permission level of the previous coding unit, the contexts of the previous coding unit are initialized, so that different encoding requirements are met.

As an example, current coding units with different permission levels each use a set of contexts, and current coding units with a same permission level share a set of contexts, so that resource waste is avoided.

As an example, different entropy encoders are used to respectively encode the related encoding coefficients corresponding to the coding units in the regions with different permission levels and adjustment parameters, and the related encoding coefficients and the adjustment parameters are correspondingly encoded into different code streams. Therefore, adjustment requirements of corresponding encoding coefficients of the regions with different permission levels are met.

As an example, quantization step adjustment parameters of the coding units in the regions with different permission levels are encoded into a code stream corresponding to a coding unit in a region with a lowest permission level. Therefore, for corresponding encoding coefficients (coding units) of regions with respective permission levels, the quantization step adjustment parameters can be referred to.

As an example, different code streams may be spliced in an image-level code stream splicing manner, a slice-level code stream splicing manner, a largest coding unit-level code stream splicing manner, a coding unit-level code stream splicing manner, or the like.

As an example, at a position of an end code of the current frame and/or a position of a start code of a next frame, according to a permission level of a coding unit with a non-lowest permission level, a code stream with the permission level corresponding to the coding unit with the non-lowest permission level and a start code and/or an end code of the code stream with the permission level of the coding unit with the non-lowest permission level, and/or a code stream with length information of the code stream corresponding to the coding unit with the non-lowest permission level are spliced and placed; or at a start position of a code stream with a non-lowest permission level and a position of a start code of a next slice and/or a position of an end code of a current slice, a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level are spliced and placed; or at a start position of a code stream with a non-lowest permission level and a position of a start code of a next LCU and/or a position of an end code of a current LCU, a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level are spliced and placed; or if the permission level of the current coding unit is not equal to a permission level of a previous coding unit, a start code of a code stream of the current coding unit and/or an end code of the previous coding unit and/or length information of a code stream corresponding to the previous coding unit are encoded and are then written into the code stream of the current coding unit, so that, subsequently, a to-be-parsed code stream of a corresponding coding unit is found quickly, and decoding efficiency is improved.

FIG. 4 corresponds to a common video encoding framework. The encoding framework is applicable to the present disclosure, and includes modules such as a prediction module, a transform module, a quantization module, an entropy encoding module, and a filtering module. The modules will be briefly introduced.
(1) The prediction module includes intra-frame prediction and inter-frame prediction, where the intra-frame prediction is prediction performed by using reconstructed pixels around a current block, to remove space redundancy; the inter-frame prediction is prediction performed by using reconstructed pixels in a time-domain reference frame, to remove time redundancy.
(2) The transform module linearly maps residual information in a space domain to a transform domain (for example, a frequency domain), with the goal of enabling energy to be more concentrated and removing frequency domain correlation of signals. A theoretical transform matrix is reversible, and no signal loss is brought.
(3) The quantization module involves a “many-to-one” mapping process, which is irreversible and brings signal loss. Its advantage is that a value range of a signal can be greatly reduced, and thereby an encoder can give good approximation of an original signal by using a small number of symbols, improving a compression rate.
(4) The entropy encoding module converts a series of element symbols (such as transform coefficients and mode information) used to represent a video sequence into a binary code stream based on a lossless encoding scheme of an information entropy principle, to remove statistical redundancy of these video element symbols.
(5) The filtering module enhances a reconstructed image, with the goal of enabling the reconstructed image to be closer to an original image, while reducing the influence of a blocking effect and a ringing effect, and improving the quality of the reconstructed image.

The above introduction is given by taking encoding as an example. A video decoding process is relative to a video encoding process, that is, video decoding usually includes processes such as an entropy decoding process, a prediction process, an inverse quantization process, an inverse transform process, and a filtering process. An implementation principle of each process is the same as or similar to that of entropy encoding. The filtering process includes deblocking filtering, sample adaptive compensation filtering, adaptive loop filtering, and neural network-based filtering.

Specific steps are the following steps.

At step S10, a to-be-encoded frame image is acquired, and position information of regions with different permission levels in the to-be-encoded frame image is determined.

As an example, the to-be-encoded frame image does not specifically refer to a fixed video image, but may refer to any frame video image in an original video.

As an example, the to-be-encoded frame image may be divided into regions with different permission levels.

As an example, the regions with different permission levels may be regions with two or more permission levels.

As an example, the to-be-encoded frame image is divided into regions with two permission levels, and may be specifically divided into regions that need to be masked or regions that do not need to be masked.

As an example, when the to-be-encoded frame image is divided into regions with multiple permission levels, for example, regions with three permission levels, the to-be-encoded frame image may be specifically divided into a region with a first permission level, a region with a second permission level, and a region with a third permission level.

As an example, assuming that a monitoring scenario includes a license plate region, the license plate region in the to-be-encoded frame image may be preset as a region that needs to be masked, and other non-license plate regions are preset as regions that do not need to be masked.

As an example, assuming that the scenario includes a human face region, an identity card region and other regions, the other regions may be preset as regions with a third permission level, the human face region may be preset as a region with a second permission level, and the identity card region may be preset as a region with a first permission level, where the region with the first permission level has a highest permission level.

As an example, after the to-be-encoded frame image is acquired, the position information of the regions with different permission levels in the to-be-encoded frame image may be determined based on a configuration file.

As an example, after the to-be-encoded frame image is acquired, the position information of the regions with different permission levels in the to-be-encoded frame image may be determined based on other input modes.

As an example, after the to-be-encoded frame image is acquired, position information of a region with a first permission level, a region with a second permission level, and a region with a third permission level in the to-be-encoded frame image is determined.

At step S20, the to-be-encoded frame image are divided into coding units based on the position information.

Each coding unit obtained after dividing corresponds to a region with only one permission level.

As an example, the to-be-encoded frame image are divided into the coding units based on positions of regions with permission levels.

As an example, the coding units obtained after dividing may be LCUs (largest coding unit/macroblock), or smaller units such as PUs (prediction units) or TUs (transform units).

As an example, for regions with permission levels, m*n is used as a minimum unit to mark the permission levels of the regions.

As an example, when the coding units are divided, m*n is used as a minimum permission level unit to limit the division of the coding units.

As an example, the coding units must be divided strictly according to the permission levels marked with m*n (one coding unit is marked correspondingly to one permission level).

As an example, when the coding units obtained after dividing correspond to regions with multiple permission levels, the coding units are further divided, until the coding units obtained after further dividing have been divided to a preset division depth, or the coding units obtained after further dividing correspond to regions with only one permission level.

That is, as an example, the coding units are not necessarily divided strictly according to the permission levels marked with m*n (one coding unit is marked correspondingly to multiple permission levels).

That is, as an example, the coding units are not necessarily divided strictly according to the permission levels marked with m*n, which is also embodied in that: if, after the coding units obtained after dividing are divided to the preset division depth, a size of the coding units is greater than m*n, and regions with permission levels corresponding to the coding units still have multiple different permission levels, the coding units obtained after dividing are not further divided.

As an example, if, after the coding units are divided to the preset division depth, a size of the coding units obtained after dividing is 16*16 (m*n is 8*8), and regions with permission levels corresponding to the coding units have multiple different permission levels, the coding units are not further divided.

As an example, if, after the coding units are divided to the preset division depth, the coding units obtained after dividing still correspond to regions with multiple permission levels, the permission levels of the regions corresponding to the coding units are adjusted to non-lowest permission levels of the regions.

As an example, after the coding units are divided to the preset division depth, a permission level of a region corresponding to a coding unit is a non-lowest permission level in permission levels (multiple permission levels) corresponding to the region instead of all regions.

As an example, if, after the coding units are divided to the preset division depth, a region corresponding to a coding unit has two different permission levels, a highest permission level in the two different permission levels is a permission level of the corresponding region.

As an example, if, after the to-be-encoded frame image are divided into the coding units, the coding units obtained after dividing are not divided to the preset division depth, and correspond to regions with more than one permission level, the coding units obtained after dividing are further divided, that is, the coding units are further divided, until the coding units obtained after further dividing have been divided to the preset division depth, or the coding units obtained after further dividing correspond to regions with only one permission level.

As an example, if, after the to-be-encoded frame image are divided into the coding units (CUs), the coding units obtained after dividing correspond to regions with one permission level, the coding units are not further divided.

As an example, for the to-be-encoded frame image, the coding units may include LCUs (largest coding unit/macroblock), or smaller units such as PUs (prediction units) or TUs (transform units).

As an example, each coding unit corresponds to the region with only one permission level, and when the coding units correspond to the regions with multiple permission levels, the coding units are further divided, until the coding units obtained after further dividing have been divided to the preset division depth, or the coding units obtained after further dividing correspond to the regions with only one permission level. Therefore, regions with different permission levels will not be divided excessively, and subsequently, reasonable encoding can be performed in a targeted manner based on reasonably divided regions with permission levels, that is, reasonable encoding is performed on related encoding coefficients corresponding to coding units in the regions with different permission levels (the related encoding coefficients include residual information and prediction mode information obtained by performing an early encoding operation on regions with current permission levels) to obtain a spliced data stream, which not only prevents confidentiality of regions with non-lowest permission levels from being damaged (large regions with non-lowest permission levels are classified to regions with low permission levels), but also can prevent regions with low permission levels from being not effectively restored in decoding (large regions with low permission levels are classified to regions with high permission levels, resulting in that, when the regions with the low permission levels are restored, the large regions cannot be referred to, and further, the regions with the low permission levels cannot be effectively restored).

As an example, the to-be-encoded frame image are divided into coding units based on the position information, and if each coding unit obtained after dividing corresponds to the region with only one permission level, the coding unit is allowed or disallowed to be further divided, so that different encoding requirements are met.

As an example, if each coding unit (16*16) corresponds to the region with only one permission level, the coding unit is disallowed to be further divided.

Alternatively, as an example, if each coding unit (16*16) corresponds to the region with only one permission level, the coding unit is allowed to be further divided (divided in 8*8).

As an example, when the coding unit corresponding to the region with only one permission level is allowed to be further divided, the coding unit is further divided in different sizes (divided in 4*4, and/or 8*8, and/or 16*16, and/or the like).

At step S30, for related encoding coefficients corresponding to coding units in the regions with different permission levels, entropy encoders corresponding to the permission levels are acquired, the related encoding coefficients are respectively encoded to obtain different code streams, and the different code streams are spliced, where the code streams are placed to internal code stream information of a current frame, and the code stream information of the current frame includes a code stream with a lowest permission level and at least one code stream with a permission level greater than the lowest permission level; when a permission level of a user is greater than or equal to a permission level of a current coding unit, a to-be-parsed code stream of the current coding unit is equal to a code stream with the permission level of the current coding unit, and a to-be-parsed code stream with a non-lowest permission level includes a code stream with a lowest permission level and at least one code stream with a permission level greater than the lowest permission level.

As an example, in encoding, the related encoding coefficients corresponding to the coding units in the regions with different permission levels are respectively encoded to obtain a spliced data stream.

As an example, in encoding, the related encoding coefficients corresponding to the coding units in the regions with different permission levels are respectively encoded to obtain a spliced data stream, that is, in this embodiment, there are only one-path data streams instead of multi-path data streams.

As an example, the code streams are placed to the internal code stream information of the current frame, and the code stream information of the current frame includes the code stream with the lowest permission level and the at least one code stream with the permission level greater than the lowest permission level; when the permission level of the user is greater than or equal to the permission level of the current coding unit, the to-be-parsed code stream of the current coding unit is equal to the code stream with the permission level of the current coding unit, and the to-be-parsed code stream with the non-lowest permission level includes the code stream with the lowest permission level and the at least one code stream with the permission level greater than the lowest permission level.

As an example, the related encoding coefficients include residual information and prediction mode information obtained by performing an early encoding operation on regions with current permission levels, as shown in FIG. 4.

As an example, the residual information refers to a difference between an original pixel and a predicted pixel of a to-be-encoded image.

As an example, the predicted pixel (Prediction Signal) is obtained based on a reconstructed pixel of a space domain adjacent block of a current block (which is located in a same frame image as the current block) or a time domain adjacent block of a current block (which is located in different images from the current block).

As an example, the closer the predicted pixel is to the original pixel, the smaller the residual energy obtained by subtracting between the predicted pixel and the original pixel is, and the higher the encoding compression performance is.

As an example, the step of respectively encoding the related encoding coefficients corresponding to the coding units in the regions with different permission levels to obtain the different code streams includes the following steps S31 to S32.

At step S31, different entropy encoders are used to respectively encode the related encoding coefficients corresponding to the coding units in the regions with different permission levels to obtain the different code streams.

As an example, different entropy encoders are used to respectively encode the related encoding coefficients corresponding to the coding units in the regions with different permission levels to obtain different code streams.

As an example, a first entropy encoder is used to encode related encoding coefficients corresponding to a coding unit in a region with a first permission level, a second entropy encoder is used to encode related encoding coefficients corresponding to a coding unit in a region with a second permission level, and a third entropy encoder is used to encode related encoding coefficients corresponding to a coding unit in a region with a third permission level, so that different code streams are obtained.

As an example, an entropy encoder of a coding unit corresponding to a region with a lowest permission level is used to encode other information of the to-be-encoded frame image.

As an example, after code streams corresponding to regions with different permission levels are obtained, different code streams are spliced to obtain a spliced data stream.

As an example, after code streams corresponding to regions with different permission levels are obtained, different code streams are spliced in different encoding manners to obtain a spliced data stream.

The step of using the different entropy encoders to respectively encode the related encoding coefficients corresponding to the coding units in the regions with different permission levels to obtain the different code streams includes the following step S32.

At step S32, different entropy encoders are used to respectively encode the related encoding coefficients corresponding to the coding units in the regions with different permission levels and adjustment parameters and correspondingly encode the related encoding coefficients and the adjustment parameters into different code streams.

As an example, the adjustment parameters may be quantization parameters (QPs).

As an example, for QPs of a coding unit in a region with a permission level a1, a corresponding entropy encoder is used to encode the QPs together with related encoding coefficients corresponding to the coding unit in the region with the permission level a1, and correspondingly encode the QPs and the related encoding coefficients into a corresponding code stream.

As an example, for QPs of a coding unit in a region with a permission level b1 (which is higher than the permission level a1), a corresponding entropy encoder is used to encode the QPs together with related encoding coefficients corresponding to the coding unit in the region with the permission level b1, and correspondingly encode the QPs and the related encoding coefficients into a corresponding code stream.

As an example, for the adjustment parameters of the coding units in the regions with different permission levels, different entropy encoders are used to respectively encode the adjustment parameters and the related encoding coefficients corresponding to the coding units in the regions with different permission levels and correspondingly encode the adjustment parameters and the related encoding coefficients into different code streams, so that, for a coding unit corresponding to a region with a low permission level (the region with the permission level a1), adjustment parameters corresponding to a coding unit corresponding to a region with a non-lowest permission level (the region with the permission level b1) cannot be referred to (in a code stream corresponding to the region with the non-lowest permission level, for example, the region with the permission level b1), and for the coding unit corresponding to the region with the non-lowest permission level, adjustment parameters corresponding to the coding unit corresponding to the region with the low permission level can be referred to (in a code stream corresponding to the region with the low permission level, for example, the region with the permission level a1).

As an example, the adjustment parameters include quantization step adjustment parameters, and the quantization step adjustment parameters of the coding units in the regions with different permission levels are placed into a code stream corresponding to a region with a lowest permission level.

As an example, the quantization step adjustment parameters are placed into the code stream corresponding to the region with the lowest permission level (for example, the region with the permission level a1 is the region with the lowest permission level), and if the coding units are allowed to be adjusted one by one, the coding units corresponding to the regions with different permission levels (for example, the region with the permission level b1) can be adjusted based on the quantization step adjustment parameters.

Before the step of using the different entropy encoders to respectively encode the related encoding coefficients corresponding to the coding units in the regions with different permission levels to obtain the different code streams, the method includes the following steps S01-S03:

At step S01, a reference region of a region with a current permission level is determined, where the reference region is a region with a permission level lower than or equal to the current permission level and with reconstructed pixels.

In this embodiment, how to obtain the residual information will be described.

As an example, the reference region of the region with the current permission level is first determined, where, when an encoding end determines the residual information, it is clear that the reference region is the region with the permission level lower than or equal to the current permission level and with the reconstructed pixels.

As an example, if the region with the current permission level is a region with a permission level b2, and space domain adjacent blocks of the region with the permission level b2 are the region with the permission level a1, the region with the permission level b1, and a region with a permission level c1, where the permission level of the region with the permission level a1 is lower than the permission level of the region with the permission level b2, the permission level of the region with the permission level b1 is equal to the permission level of the region with the permission level b2, and the permission level of the region with the permission level c1 is greater than the permission level of the region with the permission level b2, it is determined that a permission level of a reference region of the region with the current permission level b2 is lower than or equal to the current permission level (the reference region is the region with the permission level a1 or the region with the permission level b1, but cannot be the region with the permission level c1), and the reference region is the region with the reconstructed pixels.

At step S02, an optimal reconstructed pixel corresponding to the reference region is used as a predicted pixel of the region with the current permission level.

As an example, an optimal reconstructed pixel corresponding to the reference region is used as a predicted pixel of the region with the current permission level.

As an example, if the reference region is the region with the permission level a1 or the region with the permission level b1, the optimal reconstructed pixel is selected from reconstructed pixels corresponding to the region with the permission level a1 or the region with the permission level b1 as the predicted pixel of the region with the current permission level.

As an example, if the reference region is the region with the permission level a1 or the region with the permission level b1, a reconstructed pixel having a highest similarity to the region with the current permission level is selected from reconstructed pixels corresponding to the region with the permission level a1 or the region with the permission level b1 as the predicted pixel of the region with the current permission level.

At step S03, residual information of the region with the current permission level. is determined based on the predicted pixel.

As an example, residual information between the predicted pixel and a pixel of the region with the current permission level is directly calculated.

The present disclosure provides encoding and decoding methods, apparatuses and devices and storage media. Compared with related technologies where rough division of coding units is performed on a sensitive information region in a video frame, that is, an entire macroblock is determined as a sensitive information region or a non-sensitive information region, resulting in unreasonable encoding, in the present disclosure, the to-be-encoded frame image is acquired, and the position information of the regions with different permission levels in the to-be-encoded frame image is determined; the to-be-encoded frame image are divided into the coding units based on the position information, where each coding unit corresponds to the region with only one permission level; the related encoding coefficients corresponding to the coding units in the regions with different permission levels are respectively encoded to obtain different code streams, and the different code streams are spliced. Therefore, the regions with different permission levels will not be divided excessively (the sensitive information region or the non-sensitive information region), and subsequently, reasonable encoding can be performed in a targeted manner based on reasonably divided regions with permission levels, that is, reasonable encoding is performed on the related encoding coefficients corresponding to the coding units in the regions with different permission levels to obtain a spliced data stream, which not only prevents confidentiality of regions with non-lowest permission levels from being damaged (large regions with non-lowest permission levels are classified to regions with low permission levels), but also can prevent regions with low permission levels from being not effectively restored in decoding (large regions with low permission levels are classified to regions with non-lowest permission levels, resulting in that, when the regions with the low permission levels are restored, the large regions cannot be referred to, and further, the regions with the low permission levels cannot be effectively restored).

Further, based on the above embodiment of the present disclosure, another embodiment of the application is provided. In this embodiment, the step of using the different entropy encoders to respectively encode the related encoding coefficients corresponding to the coding units in the regions with different permission levels to obtain the different code streams includes the following step.

At step M1, the different entropy encoders are used and a set of contexts is acquired to respectively encode the related encoding coefficients corresponding to the coding units in the regions with different permission levels to obtain the different code streams.

As an example, the coding units in the regions with different permission levels use different entropy encoders, and have different entropy encoding states.

As an example, each coding unit in the regions with the permission levels acquires a separate entropy encoder and a set of contexts, and parses a to-be-parsed code stream.

As an example, each coding unit in the regions with the permission levels acquires a separate entropy encoder, that is, each different coding unit has a different entropy encoding state.

As an example, each coding unit in the regions with the permission levels acquires a set of contexts in addition to a separate entropy encoder, and parses a to-be-parsed code stream.

As an example, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

As an example, a coding unit with a non-lowest permission level uses a first set of contexts of a coding unit with a lowest permission level as its second set of contexts, only the coding unit with the lowest permission level can update its first set of contexts, and the coding unit with the non-lowest permission level cannot update any context.

As an example, if the permission level of the current coding unit is the same as or higher than a permission level of a previous coding unit, contexts of the previous coding unit are updated, and if the permission level of the current coding unit is lower than the permission level of the previous coding unit, the contexts of the previous coding unit are initialized.

As an example, current coding units with different permission levels each use a set of contexts, and current coding units with a same permission level share a set of contexts.

As an example, there include the following cases.
1) The permission level of the current coding unit is acquired, and when the current coding unit (with a lowest permission level) uses an entropy encoder to encode, its used contexts are a first set of contexts, where only the coding unit with a lowest permission level can update its corresponding contexts, i.e., the first set of contexts; when the current coding unit (with a non-lowest permission level) uses an entropy encoder to encode, its used contexts are a second set of contexts copied with the updated first set of contexts. In the case 1), correspondingly, only one set of contexts (the first set of contexts updated by the coding unit with the lowest permission level) needs to be stored.
2) As an example, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

Specifically, an entropy encoder corresponding to the coding unit with the lowest permission level uses contexts with a lowest permission level. For an entropy encoder corresponding to the coding unit with the non-lowest permission level, all updated contexts corresponding to a current lowest permission level are first copied. If it is allowed to update any context (the permission level of the current coding unit is higher than or equal to the permission level of the previous coding unit), all the acquired updated contexts are re-updated for use by the current coding unit to encode the corresponding to-be-parsed code stream.

After encoding the to-be-parsed code stream corresponding to the current coding unit is completed, the state of contexts is restored to a state of contexts corresponding to the coding unit with the lowest permission level. In 2), two sets of contexts (the contexts corresponding to the coding unit with the lowest permission level, and the contexts copied with the updated first set of contexts and re-updated) need to be stored, but the contexts corresponding to the coding unit with the lowest permission level can be correspondingly used by coding units with all permission levels.
3) If the permission level of the current coding unit is higher than or equal to the permission level of the previous coding unit, contexts updated by the previous coding unit are allowed to be updated; otherwise, the contexts updated by the previous coding unit are initialized.
4) Contexts are a set of contexts, instead of one context, that is, different syntaxes exist in entropy encoding, and some syntaxes correspond to separate contexts. Therefore, when the contexts are updated, only contexts of some syntax elements corresponding to the current coding unit or contexts of all syntax elements corresponding to the current coding unit can be updated.

In this embodiment, the coding units with different permission levels use corresponding contexts to encode, which adapts to different encoding scenarios.

Further, based on the above embodiment of the present disclosure, another embodiment of the application is provided. In this embodiment, the step of splicing the different code streams includes the following step.

At step N10, the different code streams are spliced in a preset splicing manner

The preset splicing manner includes a frame-level splicing manner, a slice-level splicing manner, an LCU-level splicing manner, or a CU-level splicing manner.

The splicing manner includes an image-level code stream splicing manner, a slice-level code stream splicing manner, a largest coding unit-level code stream splicing manner, or a coding unit-level code stream splicing manner.

In the image-level code stream splicing manner, the slice-level code stream splicing manner, the largest coding unit-level code stream splicing manner, and the coding unit-level code stream splicing manner, code streams corresponding to regions with a non-lowest permission level are correspondingly placed in different code stream structures.

As an example, in the image-level code stream splicing manner and the slice-level code stream splicing manner, code streams corresponding to regions with a non-lowest permission level (including a code stream with length information) are correspondingly placed in extension information of a to-be-encoded image header.

As an example, the step of splicing the different code streams in the frame-level splicing manner includes the following step.

At step N11, at a position of an end code of the current frame and/or a position of a start code of a next frame, according to a permission level of a coding unit with a non-lowest permission level, a code stream with the permission level corresponding to the coding unit with the non-lowest permission level and a start code and/or an end code of the code stream with the permission level of the coding unit with the non-lowest permission level, and/or a code stream with length information of the code stream corresponding to the coding unit with the non-lowest permission level are spliced and placed.

As an example, the frame-level splicing manner is as shown in FIG. 8 (refer to how to acquire the to-be-parsed code stream in decoding). At the position of the end code of the current frame and/or the position of the start code of the next frame, according to the permission level of the coding unit with the non-lowest permission level, the code stream with the permission level corresponding to the coding unit with the non-lowest permission level and the start code and/or the end code of the code stream with the permission level of the coding unit with the non-lowest permission level, and/or the code stream with the length information of the code stream corresponding to the coding unit with the non-lowest permission level are spliced and placed.

As an example, at the position of the end code of the current frame and/or the position of the start code of the next frame, according to the permission level of the coding unit with the non-lowest permission level, the code stream with the permission level corresponding to the coding unit with the non-lowest permission level and the start code and/or the end code of the code stream with the permission level of the coding unit with the non-lowest permission level are spliced and placed.

As an example, at the position of the end code of the current frame and/or the position of the start code of the next frame, according to the permission level of the coding unit with the non-lowest permission level, the code stream with the length information of the code stream corresponding to the coding unit with the non-lowest permission level is spliced and placed.

As an example, according to the permission level of the coding unit with the non-lowest permission level, the code stream with the permission level corresponding to the coding unit with the non-lowest permission level and the start code and/or the end code of the code stream with the permission level of the coding unit with the non-lowest permission level, and the code stream with the length information of the code stream corresponding to the coding unit with the non-lowest permission level are spliced and placed.

As an example, for coding units with different permission levels (3 levels), code streams are sorted and placed in an order of a lowest permission level, a second-to-last low permission level, and a highest permission level, where a start code and/or an end code are/is correspondingly set (the code stream with the permission level corresponding to the coding unit with the non-lowest permission level and the start code and/or the end code of the code stream with the permission level of the coding unit with the non-lowest permission level, and/or the code stream with the length information of the code stream corresponding to the coding unit with the non-lowest permission level are spliced and placed).

The step of splicing the different code streams in the slice-level splicing manner includes the following step.

At a start position of a code stream with a non-lowest permission level and a position of a start code of a next slice and/or a position of an end code of a current slice, a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level are spliced and placed.

As an example, in the slice-level splicing manner, a start code of a region with a non-lowest permission level is newly added, so that a corresponding code stream can be quickly acquired in subsequent decoding.

As an example, the slice-level splicing manner is as shown in FIG. 9 (refer to how to acquire the to-be-parsed code stream in decoding). At the start position of the code stream with the non-lowest permission level and the position of the start code of the next slice and/or the position of the end code of the current slice, the code stream with the permission level corresponding to the coding unit with the non-lowest permission level and the start code and/or the end code of the code stream with the permission level of the coding unit with the non-lowest permission level, and/or the code stream with the length information of the code stream corresponding to the coding unit with the non-lowest permission level are spliced and placed.

As an example, the step of splicing the different code streams in the LCU-level splicing manner includes the following step.

At a start position of a code stream with a non-lowest permission level and a position of a start code of a next LCU and/or a position of an end code of a current LCU, a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level are spliced and placed.

As an example, in the LCU-level splicing manner, a start code of an LCU and a start code of a region with a non-lowest permission level are newly added, so that a corresponding code stream can be quickly acquired in subsequent decoding.

As an example, the step of splicing the different code streams in the CU-level splicing manner includes the following step.

If the permission level of the current coding unit is not equal to a permission level of a previous coding unit, a start code of a code stream of the current coding unit and/or an end code of the previous coding unit and/or length information of a code stream corresponding to the previous coding unit are encoded and then written into the code stream of the current coding unit.

In this embodiment, the different code streams are spliced in the preset splicing manner, and the preset splicing manner includes the frame-level splicing manner, the slice-level splicing manner, the LCU-level splicing manner, or the CU-level splicing manner, so that, subsequently, the to-be-parsed code stream of the current coding unit is found quickly, and parsing requirements are met.

FIG. 3 is a schematic structural diagram of a device in a hardware running environment involved in an embodiment solution according to the present disclosure.

As shown in FIG. 3, a decoding device may include: a processor 1001, a memory 1005, and a communication bus 1002. The communication bus 1002 is configured to implement connection and communication between the processor 1001 and the memory 1005.

Optionally, the decoding device may further include user interfaces, network interfaces, cameras, RF (Radio Frequency) circuits, sensors, Wi-Fi modules, etc. The user interfaces may include a display, and input sub-modules such as a keyboard. Optionally, the user interfaces may further include standard wired interfaces and wireless interfaces. The network interfaces may include standard wired interfaces and wireless interfaces (such as Wi-Fi interfaces).

A person skilled in the art can understand that a structure of the decoding device shown in FIG. 3 does not constitute a limitation on the decoding device, and may include more or less components that those shown in the figure, or combinations of some components, or different component arrangements.

As shown in FIG. 3, the memory 1005 as a storage medium may include an operating system, a network communication module, and a decoding program. The operating system is a program that manages and controls hardware and software resources of the decoding device, and supports running of the decoding program and other software and/or programs. The network communication module is configured to implement communication between components in the memory 1005, as well as communication with other hardware and software in a decoding apparatus.

In the decoding device shown in FIG. 3, the processor 1001 is configured to execute the decoding program stored in the memory 1005 to implement the steps of the decoding method as described above.

Specific implementation manners of the decoding device in the present disclosure are substantially the same as that in the embodiments of the decoding method, which will not be described herein again.

The present disclosure further provides a decoding apparatus, including: a first acquiring module, configured to acquire a permission level of a user and a permission level of a current coding unit; a second acquiring module, configured to acquire a to-be-parsed code stream of the current coding unit according to the permission level of the user and the permission level of the current coding unit, where the code stream is acquired from internal code stream information of a current frame, and the code stream information of the current frame includes a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level includes a code stream with a lowest permission level and at least one code stream with a permission level greater than the lowest permission level; a parsing module, configured to acquire an entropy decoder corresponding to permission levels according to the permission level of the user, the permission level of the current coding unit, and a corresponding code stream, and parse the to-be-parsed code stream to obtain a reconstructed image block of the current coding unit.

In an embodiment of the present disclosure, the apparatus is configured to: acquire the permission level of the current coding unit from an image header of the current frame or internal code stream information with a non-permission level of the current frame.

In an embodiment of the present disclosure, the current coding unit has only one permission level.

In an embodiment of the present disclosure, when the permission level of the current coding unit is acquired from the image header of the current frame, if it is determined that the current coding unit corresponds to a plurality of permission levels, a highest permission level in the plurality of permission levels is used as the permission level of the current coding unit.

In an embodiment of the present disclosure, the apparatus is configured to: acquire the to-be-parsed code stream of the current coding unit according to the permission level of the user and the permission level of the current coding unit, where the to-be-parsed code stream includes a related encoding coefficient code stream of the current coding unit and an adjustment parameter code stream.

In an embodiment of the present disclosure, the apparatus is configured to: acquire a to-be-parsed related encoding coefficient code stream of the current coding unit according to the permission level of the user and the permission level of the current coding unit; and acquire the quantization step adjustment parameter code stream from code streams with a lowest permission level.

In an embodiment of the present disclosure, the apparatus is configured to: acquire the entropy decoder corresponding to the permission levels according to the permission level of the user, the permission level of the current coding unit, and the corresponding code stream, acquire a set of contexts, and parse the to-be-parsed code stream.

In an embodiment of the present disclosure, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

In an embodiment of the present disclosure, when contexts are updated, only contexts of some syntax elements corresponding to the current coding unit or contexts of all syntax elements corresponding to the current coding unit are updated.

In an embodiment of the present disclosure, a coding unit with a non-lowest permission level uses a first set of contexts of a coding unit with a lowest permission level as its second set of contexts, only the coding unit with the lowest permission level can update its first set of contexts, and the coding unit with the non-lowest permission level cannot update any context.

In an embodiment of the present disclosure, if the permission level of the current coding unit is the same as or higher than a permission level of a previous coding unit, contexts of the previous coding unit are updated, and if the permission level of the current coding unit is lower than the permission level of the previous coding unit, the contexts of the previous coding unit are initialized.

In an embodiment of the present disclosure, current coding units with different permission levels each use a set of contexts, and current coding units with a same permission level share a set of contexts.

In an embodiment of the present disclosure, the apparatus is configured to: acquire the to-be-parsed code stream of the current coding unit according to the permission level of the user, the permission level of the current coding unit, and a start code and/or an end code of a code stream with the permission level of the current coding unit.

In an embodiment of the present disclosure, if splicing manners of code streams of different coding units are frame-level splicing manners, the apparatus is configured to: read a position of an end code of the current frame and/or a position of a start code of a next frame; according to the permission level of the user and the permission level of the current coding unit, if the current coding unit is a first coding unit under a current permission level of the current frame, derive a start position of a code stream of the current coding unit based on the position of the end code of the current frame and/or the position of the start code of the next frame, and a start code of a code stream under a current permission level or length information of a code stream under a previous permission level of the current permission level; otherwise, directly acquire the start position of the code stream of the current coding unit, where the current permission level refers to the permission level corresponding to the current coding unit, so that the to-be-parsed code stream is parsed, and after completion of parsing, a start position of the code stream with the permission level corresponding to the current coding unit is updated.

In an embodiment of the present disclosure, if splicing manners of code streams of different coding units are slice-level splicing manners, the apparatus is configured to: read a start position of a code stream with a non-lowest permission level, and a position of a start code of a next slice and/or a position of an end code of a current slice; according to the permission level of the user and the permission level of the current coding unit, if the current coding unit is a first coding unit under a current permission level of the current slice, derive a start position of a code stream of the current coding unit based on the position of the end code of the current slice and/or the position of the start code of the next slice, and a start code of a code stream under a current permission level or length information of a code stream under a previous permission level of the current permission level; otherwise, directly acquire the start position of the code stream of the current coding unit, so that the to-be-parsed code stream is parsed, and after completion of parsing, a start position of the code stream with the permission level corresponding to the current coding unit is updated.

In an embodiment of the present disclosure, if splicing manners of code streams of different coding units are largest coding unit LCU-level splicing manners, the apparatus is configured to: read a start position of a code stream with a non-lowest permission level, and a position of a start code of a next LCU and/or a position of an end code of a current LCU; according to the permission level of the user and the permission level of the current coding unit, if the current coding unit is a first coding unit under a current permission level of the current LCU, derive a start position of a code stream of the current coding unit based on the position of the end code of the current LCU and/or the position of the start code of the next LCU, and a start code of a code stream under a current permission level or length information of a code stream under a previous permission level of the current permission level; otherwise, directly acquire the start position of the code stream of the current coding unit, so that the to-be-parsed code stream is parsed, and after completion of parsing, a start position of the code stream with the permission level corresponding to the current coding unit is updated.

In an embodiment of the present disclosure, the apparatus is configured to: the step of acquiring the to-be-parsed code stream of the current coding unit according to the permission level of the user, the permission level of the current coding unit, and the start code and/or the end code of the code stream with the permission level of the current coding unit includes: if the permission level of the current coding unit is a non-lowest permission level and the permission level of the current coding unit is not equal to a permission level of a previous coding unit, acquiring the start code of the code stream with the permission level of the current coding unit, or an end code of the previous coding unit, or a length of a code stream of the previous coding unit, and deriving a start position of a code stream of the current coding unit according to the acquired start code of the code stream with the permission level of the current coding unit, or end code of the previous coding unit, or length of the code stream of the previous coding unit, and a start position of the code stream of the previous coding unit; otherwise, deriving the start position of the code stream of the current coding unit according to the start position of the code stream of the previous coding unit.

In an embodiment of the present disclosure, when the permission level of the user is less than the permission level of the current coding unit, the code stream with the permission level of the current coding unit is not decoded, and code streams without a permission level are decoded, to obtain the reconstructed image block of the current coding unit.

In an embodiment of the present disclosure, when the permission level of the user is less than the permission level of the current coding unit, the code stream with the permission level of the current coding unit is not decoded, and a fixed image block or image block information of coding units around the current coding unit with a permission level less than or equal to the permission level of the current coding unit is used to derive the reconstructed image block of the current coding unit.

Specific implementation manners of the decoding apparatus in the present disclosure are substantially the same as that in the embodiments of the decoding method, which will not be described herein again.

The present disclosure further provides an encoding apparatus, including: a third acquiring module, configured to acquire a to-be-encoded frame image, and determine position information of regions with different permission levels in the to-be-encoded frame image; a dividing module, configured to divide the to-be-encoded frame image into coding units based on the position information, where each coding unit corresponds to a region with only one permission level; an encoding module, configured to, for related encoding coefficients corresponding to coding units in the regions with different permission levels, acquire entropy encoders corresponding to the permission levels, respectively encode the related encoding coefficients to obtain different code streams, and splice the different code streams, where the code streams are placed to internal code stream information of a current frame, and the code stream information of the current frame includes a code stream with a lowest permission level and at least one code stream with a permission level greater than the lowest permission level; when a permission level of a user is greater than or equal to a permission level of a current coding unit, a to-be-parsed code stream of the current coding unit is equal to a code stream with the permission level of the current coding unit, and a to-be-parsed code stream with a non-lowest permission level includes a code stream with a lowest permission level and at least one code stream with a permission level greater than the lowest permission level.

In an embodiment of the present disclosure, when the coding units obtained after dividing correspond to regions with multiple permission levels, the coding units obtained after dividing are further divided, until the coding units obtained after further dividing have been divided to a preset division depth, or the coding units obtained after further dividing correspond to regions with only one permission level.

In an embodiment of the present disclosure, after the coding units are divided to the preset division depth, if the coding units obtained after dividing still correspond to regions with multiple permission levels, the permission levels of the regions corresponding to the coding units are adjusted to non-lowest permission levels of the regions.

In an embodiment of the present disclosure, the to-be-encoded frame image are divided into the coding units based on the position information, and if each coding unit obtained after dividing corresponds to the region with only one permission level, the coding unit is allowed or disallowed to be further divided.

In an embodiment of the present disclosure, when the coding unit corresponding to the region with only one permission level is allowed to be further divided, the coding unit is further divided in different sizes.

In an embodiment of the present disclosure, the encoding apparatus is configured to:
use different entropy encoders to respectively encode the related encoding coefficients corresponding to the coding units in the regions with different permission levels to obtain the different code streams.

In an embodiment of the present disclosure, the encoding apparatus is configured to: use the different entropy encoders and acquire a set of contexts to respectively encode the related encoding coefficients corresponding to the coding units in the regions with different permission levels to obtain the different code streams.

In an embodiment of the present disclosure, contexts corresponding to a coding unit with a lowest permission level are a first set of contexts, contexts corresponding to a coding unit with a non-lowest permission level are a second set of contexts, and before the second set of contexts is obtained, an updated first set of contexts is first copied and is re-updated.

In an embodiment of the present disclosure, a coding unit with a non-lowest permission level uses a first set of contexts of a coding unit with a lowest permission level as its second set of contexts, only the coding unit with the lowest permission level can update its first set of contexts, and the coding unit with the non-lowest permission level cannot update any context.

In an embodiment of the present disclosure, if the permission level of the current coding unit is the same as or higher than a permission level of a previous coding unit, contexts of the previous coding unit are updated, and if the permission level of the current coding unit is lower than the permission level of the previous coding unit, the contexts of the previous coding unit are initialized.

In an embodiment of the present disclosure, current coding units with different permission levels each use a set of contexts, and current coding units with a same permission level share a set of contexts.

In an embodiment of the present disclosure, the step of using the different entropy encoders to respectively encode the related encoding coefficients corresponding to the coding units in the regions with different permission levels to obtain the different code streams includes:
using different entropy encoders to respectively encode the related encoding coefficients corresponding to the coding units in the regions with different permission levels and adjustment parameters and correspondingly encode the related encoding coefficients and the adjustment parameters into different code streams.

In an embodiment of the present disclosure, the adjustment parameters include quantization step adjustment parameters, and the quantization step adjustment parameters of the coding units in the regions with different permission levels are encoded into a code stream corresponding to a coding unit in a region with a lowest permission level.

In an embodiment of the present disclosure, the encoding apparatus is configured to: splice the different code streams in a preset splicing manner.

The preset splicing manner includes a frame-level splicing manner, a slice-level splicing manner, an LCU-level splicing manner, or a CU-level splicing manner.

In an embodiment of the present disclosure, the encoding apparatus is configured to:
at a position of an end code of the current frame and/or a position of a start code of a next frame, according to a permission level of a coding unit with a non-lowest permission level, splice and place a code stream with the permission level corresponding to the coding unit with the non-lowest permission level, or a code stream with length information of the code stream corresponding to the coding unit with the non-lowest permission level.

In an embodiment of the present disclosure, the encoding apparatus is configured to:
at a position of an end code of the current frame and/or a position of a start code of a next frame, according to a permission level of a coding unit with a non-lowest permission level, splice and place a code stream with the permission level corresponding to the coding unit with the non-lowest permission level and a start code and/or an end code of the code stream with the permission level of the coding unit with the non-lowest permission level, and/or a code stream with length information of the code stream corresponding to the coding unit with the non-lowest permission level.

In an embodiment of the present disclosure, the encoding apparatus is configured to:
at a start position of a code stream with a non-lowest permission level and a position of a start code of a next slice and/or a position of an end code of a current slice, splice and place a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level.

In an embodiment of the present disclosure, the encoding apparatus is configured to:
at a start position of a code stream with a non-lowest permission level and a position of a start code of a next LCU and/or a position of an end code of a current LCU, splice and place a code stream with a permission level corresponding to a coding unit with a non-lowest permission level and a start code and/or an end code of the code stream with the permission level of the coding unit with the non-lowest permission level, and/or a code stream with length information of the code stream corresponding to the coding unit with the non-lowest permission level.

In an embodiment of the present disclosure, the encoding apparatus is configured to:
if the permission level of the current coding unit is not equal to a permission level of a previous coding unit, encode and then write a start code of a code stream of the current coding unit and/or an end code of the previous coding unit and/or length information of a code stream corresponding to the previous coding unit into the code stream of the current coding unit.

Specific implementation manners of the encoding apparatus in the present disclosure are substantially the same as that in the embodiments of the encoding method, which will not be described herein again.

An embodiment of the present disclosure provides a storage medium, and the storage medium stores one or more programs, where the one or more programs can be executed by one or more processors to implement the steps of the decoding method as described above.

Specific implementation manners of the storage medium in the present disclosure are substantially the same as that in the embodiments of the decoding method, which will not be described herein again.

An embodiment of the present disclosure provides a storage medium, and the storage medium stores one or more programs, where the one or more programs can be executed by one or more processors to implement the steps of the encoding method as described above.

Specific implementation manners of the storage medium in the present disclosure are substantially the same as that in the embodiments of the encoding method, which will not be described herein again.

The present disclosure further provides a computer program product, including a computer program, where the computer program is executed by a processor to implement the steps of the encoding method as described above.

Specific implementation manners of the computer program product in the present disclosure are substantially the same as that in the embodiments of the encoding method, which will not be described herein again.

It shall be noted that, here, the term “including”, “containing” or any other variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The order of the embodiments of the present invention is only for description, but does not represent the advantages or disadvantages of the embodiments.

From the description of the above embodiments, a person skilled in the art can clearly understand that the methods in the embodiments can be implemented by software plus a hardware platform or by hardware, but in many cases, the former is a better implement manner. Based on such understanding, the technical solutions of the present invention essentially or the part contributing to the prior art may be embodied in the form of a software product. The computer software product is stored in a storage medium (such as ROM/RAM), including several instructions for enabling a terminal device (which may be a mobile phone, a computer, a server, an air conditioner, a network device, etc.) to execute the methods in the embodiments of the present invention.

The above are only preferred embodiments of the present invention, but do not therefore limit the patent scope of the invention. Equivalent structures or equivalent process transformations made by using contents of the specification and the drawings of the invention or those directly or indirectly applied to other related technical fields are similarly included in the patent protection scope of the invention.

1. A decoding method, comprising:
acquiring a permission level of a user and a permission level of a current coding unit;
acquiring a to-be-parsed code stream of the current coding unit according to the permission level of the user and the permission level of the current coding unit, wherein the code stream is acquired from internal code stream information of a current frame, and the code stream information of the current frame comprises a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level comprises a code stream with a lowest permission level and at least one code stream with a permission level greater than the lowest permission level; and
acquiring an entropy decoder corresponding to permission levels according to the permission level of the user, the permission level of the current coding unit, and a corresponding code stream, and parsing the to-be-parsed code stream to obtain a reconstructed image block of the current coding unit.

2. The decoding method according to claim 1, wherein acquiring the permission level of the current coding unit comprises:
acquiring the permission level of the current coding unit from an image header of the current frame or internal code stream information with a non-permission level of the current frame.

3. The decoding method according to claim 2, wherein the current coding unit has only one permission level.

4. The decoding method according to claim 3, wherein when the permission level of the current coding unit is acquired from the image header of the current frame, in response to determining that the current coding unit corresponds to a plurality of permission levels, a highest permission level in the plurality of permission levels is used as the permission level of the current coding unit.

5. The decoding method according to claim 3, wherein acquiring the to-be-parsed code stream of the current coding unit according to the permission level of the user and the permission level of the current coding unit comprises:
acquiring the to-be-parsed code stream of the current coding unit according to the permission level of the user and the permission level of the current coding unit, wherein the to-be-parsed code stream comprises an adjustment parameter code stream and a related encoding coefficient code stream of the current coding unit.

6. The decoding method according to claim 5, wherein the adjustment parameter code stream comprises a quantization step adjustment parameter code stream, and acquiring the to-be-parsed code stream of the current coding unit according to the permission level of the user and the permission level of the current coding unit comprises:
acquiring a to-be-parsed related encoding coefficient code stream of the current coding unit according to the permission level of the user and the permission level of the current coding unit; and
acquiring the quantization step adjustment parameter code stream from code streams with a lowest permission level.

7. The decoding method according to claim 1, wherein acquiring the entropy decoder corresponding to the permission levels according to the permission level of the user, the permission level of the current coding unit, and the corresponding code stream, and parsing the to-be-parsed code stream comprise:
acquiring the entropy decoder corresponding to the permission levels according to the permission level of the user, the permission level of the current coding unit, and the corresponding code stream, acquiring a set of contexts, and parsing the to-be-parsed code stream.

8-11. (canceled)

12. The decoding method according to claim 7, wherein current coding units with different permission levels each use a set of contexts, and current coding units with a same permission level share a set of contexts.

13-17. (canceled)

18. The decoding method according to claim 1, wherein when the permission level of the user is less than the permission level of the current coding unit, the code stream with the permission level of the current coding unit is not decoded, and code streams without a permission level are decoded, to obtain the reconstructed image block of the current coding unit.

19. The decoding method according to claim 1, wherein when the permission level of the user is less than the permission level of the current coding unit, the code stream with the permission level of the current coding unit is not decoded, and a fixed image block or image block information of coding units around the current coding unit with a permission level less than or equal to the permission level of the current coding unit is used to derive the reconstructed image block of the current coding unit.

20-39. (canceled)

40. An electronic device, comprising: a memory, a processor, and computer programs stored in the memory and runnable on the processor, wherein the computer programs are executed by the processor to implement operations comprising:
acquiring a permission level of a user and a permission level of a current coding unit:
acquiring a to-be-parsed code stream of the current coding unit according to the permission level of the user and the permission level of the current coding unit, wherein the code stream is acquired from internal code stream information of a current frame, and the code stream information of the current frame comprises a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level comprises a code stream with a lowest permission level and at least one code stream with a permission level greater than the lowest permission level, and
acquiring an entropy decoder corresponding to permission levels according to the permission level of the user, the permission level of the current coding unit, and a corresponding code stream, and parsing the to-be-parsed code stream to obtain a reconstructed image block of the current coding unit.

41. A non-transitory storage medium having computer programs stored therein, wherein the computer programs are executed by a processor to implement operations comprising:
acquiring a permission level of a user and a permission level of a current coding unit;
acquiring a to-be-parsed code stream of the current coding unit according to the permission level of the user and the permission level of the current coding unit, wherein the code stream is acquired from internal code stream information of a current frame, and the code stream information of the current frame comprises a code stream with a lowest permission level and at least one code stream with a permission level greater than the lowest permission level; when the permission level of the user is greater than or equal to the permission level of the current coding unit, the to-be-parsed code stream is equal to a code stream with the permission level of the current coding unit, and a to-be-parsed code stream with a non-lowest permission level comprises a code stream with a lowest permission level and at least one code stream with a permission level greater than the lowest permission level; and
acquiring an entropy decoder corresponding to permission levels according to the permission level of the user, the permission level of the current coding unit, and a corresponding code stream, and parsing the to-be-parsed code stream to obtain a reconstructed image block of the current coding unit.

42. The electronic device according to claim 41, wherein acquiring the permission level of the current coding unit comprises:
acquiring the permission level of the current coding unit from an image header of the current frame or internal code stream information with a non-permission level of the current frame.

43. The decoding method according to claim 42, wherein the current coding unit has only one permission level.

44. The electronic device according to claim 43, wherein when the permission level of the current coding unit is acquired from the image header of the current frame, in response to determining that the current coding unit corresponds to a plurality of permission levels, a highest permission level in the plurality of permission levels is used as the permission level of the current coding unit.

45. The electronic device according to claim 43, wherein acquiring the to-be-parsed code stream of the current coding unit according to the permission level of the user and the permission level of the current coding unit comprises:
acquiring the to-be-parsed code stream of the current coding unit according to the permission level of the user and the permission level of the current coding unit, wherein the to-be-parsed code stream comprises an adjustment parameter code stream and a related encoding coefficient code stream of the current coding unit.

46. The electronic device according to claim 45, wherein the adjustment parameter code stream comprises a quantization step adjustment parameter code stream, and acquiring the to-be-parsed code stream of the current coding unit according to the permission level of the user and the permission level of the current coding unit comprises:
acquiring a to-be-parsed related encoding coefficient code stream of the current coding unit according to the permission level of the user and the permission level of the current coding unit; and
acquiring the quantization step adjustment parameter code stream from code streams with a lowest permission level.

47. The electronic device according to claim 40, wherein acquiring the entropy decoder corresponding to the permission levels according to the permission level of the user, the permission level of the current coding unit, and the corresponding code stream, and parsing the to-be-parsed code stream comprise:
acquiring the entropy decoder corresponding to the permission levels according to the permission level of the user, the permission level of the current coding unit, and the corresponding code stream, acquiring a set of contexts, and parsing the to-be-parsed code stream.

48. The electronic device according to claim 47, wherein current coding units with different permission levels each use a set of contexts, and current coding units with a same permission level share a set of contexts.

49. The electronic device according to claim 40, wherein when the permission level of the user is less than the permission level of the current coding unit, the code stream with the permission level of the current coding unit is not decoded, and code streams without a permission level are decoded, to obtain the reconstructed image block of the current coding unit; of
wherein when the permission level of the user is less than the permission level of the current coding unit, the code stream with the permission level of the current coding unit is not decoded, and a fixed image block or image block information of coding units around the current coding unit with a permission level less than or equal to the permission level of the current coding unit is used to derive the reconstructed image block of the current coding unit.
